(19) United States
(12) Patent Application Publication
(10) Pub. No.: US 2019/0065425 A1
(43) Pub. Date: Feb. 28, 2019

(54) INFORMATION PROCESSING DEVICE, INFORMATION PROCESSING METHOD, AND STORAGE MEDIUM

(71) Applicant: FUJITSU LIMITED, Kawasaki-shi (JP)

(72) Inventors: Tsutomu Noguchi, Fukuoka (JP); Toshihiro Noguchi, Fukuoka (JP); Toshimi Kida, Itoshima (JP); Naoki Fukuda, Fukuoka (JP); Naoki Kawasaki, Itoshima (JP); AKIKAZU MAEHARA, Kasuga (JP); Masamichi Kasa, Kurume (JP)

(73) Assignee: FUJITSU LIMITED, Kawasaki-shi (JP)

(21) Appl. No.: 16/100,946

(22) Filed: Aug. 10, 2018

(30) Foreign Application Priority Data
Aug. 25, 2017 (JP) 2017-162753

(51) Int. Cl. G06F 13/40; G06F 13/28

(52) U.S. Cl. CPC G06F 13/4027; G06F 13/28

(57) ABSTRACT

An information processing device includes a buffer that stores data blocks of a plurality of flows and from which the data blocks are sequentially read; a processor coupled to the buffer and configured to: monitor an input rate that is a sum of data amounts of the plurality of flows input to the buffer per unit of time, and suppress flowing of a data block into the buffer for one or more of the plurality of flows based on a result of monitoring the input rate.

### CROSS-REFERENCE TO RELATED APPLICATION

This application is based upon and claims the benefit of priority of the prior Japanese Patent Application No. 2017-162753, filed on Aug. 25, 2017, the entire contents of which are incorporated herein by reference.

### FIELD

The embodiment discussed herein is related to an information processing device, an information processing method, and a storage medium.

### BACKGROUND

In a network device such as a switch or a router, frames input to the device are temporarily stored in a buffer and read from the buffer in the order in which the frames are stored, for example. This is due to the fact that the network device has an upper limit on the processing power of the network device or that a network bandwidth is limited, for example. For example, the size of the buffer is determined based on the processing power or bandwidth of the network device in advance. If a frame is input to the buffer and causes the amount of data stored in the buffer to exceed a data amount capable of being stored in the buffer, the processing power of the network device exceeds the upper limit and the frame is discarded, for example. As related art, for example, Japanese Laid-open Patent Publication No. 2006-173726, Japanese Laid-open Patent Publication No. 2004-104192, Japanese Laid-open Patent Publication No. 2010-068052, and the like have been disclosed.

A sudden flow of a large amount of data is referred to as burst, for example. If a burst occurs, the buffer may become full of input frames and a frame may be discarded. In addition, due to a flow causing a burst, a frame of another flow sharing the buffer may be discarded, and the other flow may be affected by the flow causing the burst. A flow is a flow of multiple frames having common flow identification information. Given the above description, it is desirable to suppress the discarding, caused by a burst, of data in the buffer of the network device.

### SUMMARY

According to an aspect of the invention, an information processing device includes a buffer that stores data blocks of a plurality of flows and from which the data blocks are sequentially read; a processor coupled to the buffer and configured to: monitor an input rate that is a sum of data amounts of the plurality of flows input to the buffer per unit of time, and suppress flowing of a data block into the buffer for one or more of the plurality of flows based on a result of monitoring the input rate.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a diagram illustrating an example of relationships between the rate of inputting to a buffer and the amount of frames accumulated in the buffer;

FIG. 1B is a diagram illustrating an example of relationships between the rate of inputting a single flow to a policer among flows to be input to the buffer illustrated in FIG. 1A, the amount of tokens accumulated in a token bucket for the flow, and the amount of frames accumulated in the buffer;

FIG. 2 is a diagram illustrating an example of a functional configuration of a switch according to an embodiment;

FIG. 3 is a diagram illustrating an example of a change in the amount of tokens accumulated in a token bucket of a policer;

FIG. 4 is a diagram illustrating an example of traffic of a flow to be subjected to burst size control;

FIG. 5 is a diagram illustrating an example of traffic of a flow to be subjected to the burst size control;

FIG. 6 is a diagram illustrating an example of traffic of a flow to be subjected to the burst size control;

FIG. 7 is a diagram illustrating an example of the monitoring of the input rate by an input rate monitoring section according to the embodiment;

FIG. 8 is a diagram illustrating an example of the monitoring of an inclination of the input rate by an input rate increase and decrease monitoring section according to the embodiment;

FIGS. 9A and 9B are tables illustrating an example of details of the burst size control by a buffer monitoring section according to the embodiment;

FIG. 10 is an example of a flowchart of a process to be executed by a token monitoring section upon the reception of a frame;

FIG. 11 is an example of a flowchart of a process, to be executed by a token monitoring section, of determining a flow to be subjected to the control;

FIG. 12 is an example of a flowchart of a process to be executed by the input rate increase and decrease monitoring section;

FIG. 13A is an example of a flowchart of a process to be executed by a buffer monitoring section;

FIG. 13B is an example of a flowchart of a process to be executed by the buffer monitoring section;

FIG. 13C is an example of a flowchart of a process to be executed by the buffer monitoring section;

FIG. 13D is an example of a flowchart of a process to be executed by the buffer monitoring section;

FIG. 14 is an example of a graph indicating the rates of inputting flows A, B, and C and the total of the rates in a specific example;

FIG. 15 is an example of a graph indicating the rates of inputting the flows A, B, and C and the total of the input rates in the case where control based on a first method is executed on the buffer;

FIG. 16 is an example of a graph indicating the rates of inputting the flows A, B, and C and the total of the input rates in the case where the burst size control according to the embodiment is executed on the buffer; and

FIG. 17 is an example of a graph indicating an amount used by the buffer in the case where the burst size control according to the embodiment is executed and graph indicating an amount used by the buffer in the case where burst size control based on the first method is executed.

### DESCRIPTION OF EMBODIMENT

Hereinafter, an embodiment is described with reference to the accompanying drawings. Configurations described in the embodiment are examples, and techniques disclosed herein are not limited to the configurations described in the embodiment.

### Embodiment

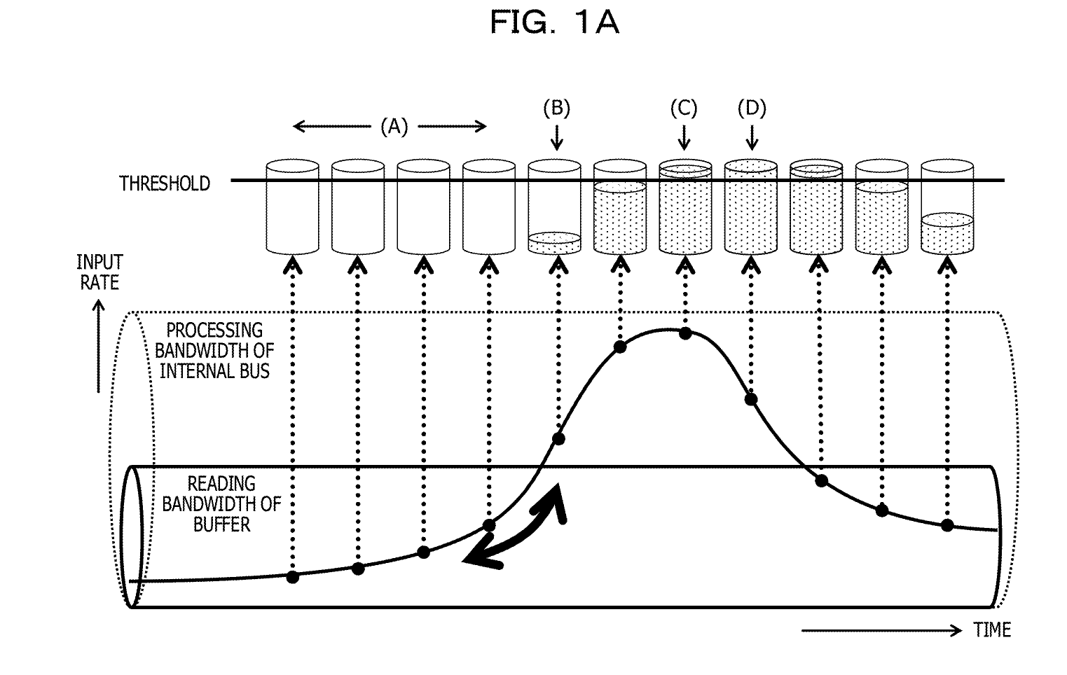

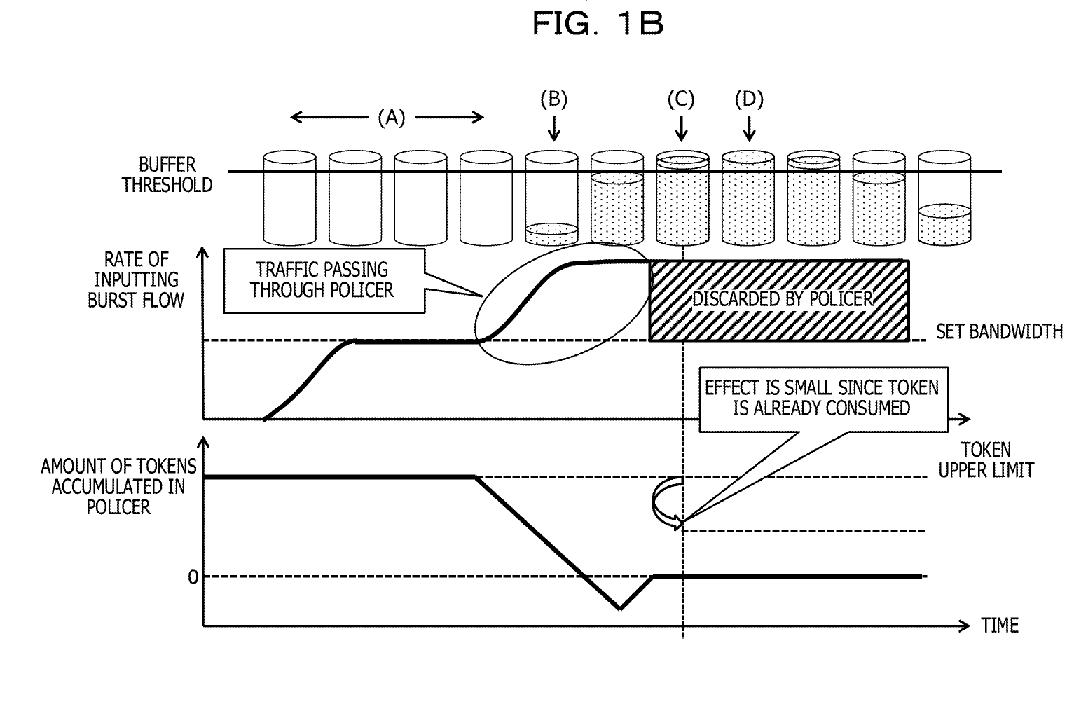

FIG. 1A is a diagram illustrating an example of relationships between the rate of inputting to a buffer and the amount of frames accumulated in the buffer. FIG. 1A illustrates, on its upper side, an example of a change in the amount of frames accumulated in the buffer. FIG. 1A also illustrates, on its lower side, a graph indicating an example of a change in the rate of inputting to the buffer.

For example, frames are input to and output from the buffer according to the first-in first-out method. It is assumed that frames of multiple flows are input to the buffer illustrated in FIG. 1A. Thus, the rate of inputting to the buffer is the total of the rates of inputting the multiple flows including the frames to the buffer. In addition, an upper limit of the amount of traffic to be input to the buffer per unit of time is a processing bandwidth of an internal bus. The frames are an example of “data blocks”. Other examples of “data blocks” are packets, datagrams, and the like.

The embodiment assumes that the amount of traffic to be input to the buffer per unit of time is a physical amount indicated by bits per second (bps) as a unit. The amount of traffic to be input to the buffer per unit of time, however, is not limited to this. The amount of traffic to be input to the buffer per unit of time is also merely referred to as input rate. A bandwidth at which a frame is read from the buffer is also referred to as reading bandwidth of the buffer or processing power of the buffer.

During the time when the rate of inputting to the buffer is lower than the reading bandwidth of the buffer as illustrated by (A) in FIG. 1A, a frame input to the buffer is output from the buffer immediately after the input of the frame. Thus, the amount of frames accumulated in the buffer is 0. At time indicated by (B) in FIG. 1A, the amount of traffic increases, the rate of inputting to the buffer exceeds the reading bandwidth of the buffer, and frames start to be accumulated in the buffer. After the time indicated by (B) in FIG. 1A, the rate of inputting to the buffer continuously exceeds the reading bandwidth of the buffer, and the amount of frames accumulated in the buffer increases. Then, at time indicated by (D) in FIG. 1A, the buffer becomes full of frames. After the buffer becomes full of the frames, a frame that arrives at the buffer is discarded. The discarding of an arriving frame due to the fact that the buffer becomes full of frames is also referred to as buffer overflow.

As one of methods for suppressing the discarding of frames in the buffer, there is a method for reducing the burst size of a policer for a flow of a large amount of traffic when the amount of frames accumulated in the buffer reaches a threshold, for example. This method is referred to as first method.

A policer is a function of executing policing to control the amount of traffic to be input to a buffer. The policing is executed on the upstream side of the buffer. A burst size of the policer is the maximum amount of traffic allowable by the policer.

In the policing, frames in an amount corresponding to tokens accumulated in a token bucket may be output according to a token bucket scheme. In the policing, if a token is not accumulated in the token bucket, a frame is discarded, for example.

A predetermined amount of tokens are added to the token bucket in each of predetermined cycles. An upper limit of the amount of tokens capable of being accumulated in the token bucket is set in the token bucket. The amount of tokens held in the token bucket does not exceed the upper limit. The upper limit of the amount of tokens capable of being accumulated in the token bucket is hereinafter referred to as token upper limit.

If the token bucket is full of tokens, the policer may output traffic for the token upper limit. Thus, the burst size of the policer is synonymous with the token upper limit. The burst size of the policer and the token upper limit are examples of the “maximum value of tokens capable of being accumulated”.

For example, in the example illustrated in FIG. 1A, if the first method is executed, the amount of frames accumulated in the buffer reaches the threshold at time indicated by (C) in FIG. 1A, and the burst size of the policer for the flow of the large amount of traffic is reduced. By reducing the burst size of the policer for the flow of the large amount of traffic, the amount of traffic passing through the policer is reduced and the amount of traffic input to the buffer is reduced. As a result, the rate of inputting to the buffer is reduced as illustrated in FIG. 1A.

FIG. 1B is a diagram illustrating an example of relationships between the rate of inputting a single flow to a policer among flows to be input to the buffer illustrated in FIG. 1A, the amount of tokens accumulated in a token bucket for the flow, and the amount of frames accumulated in the buffer. FIG. 1B illustrates, on its upper side, an example of a change in the amount of frames accumulated in the same buffer as that illustrated in FIG. 1A. Thus, time indicated by (A) to (D) in FIG. 1B is the same as the time indicated by (A) to (D) in FIG. 1A.

FIG. 1B illustrates, in its middle portion, a graph indicating an example of a change in the rate of inputting a flow including burst traffic to the policer. A flow including burst traffic is hereinafter referred to burst flow. FIG. 1B illustrates, on its lower side, a graph indicating an example of a change in the amount of tokens accumulated in the policer for a burst flow.

During the time when the rate of inputting the burst flow is equal to or lower than a set bandwidth of the policer, the amount of tokens accumulated in the policer is close to a token upper limit. At time indicated by (B) in FIG. 1B, the burst traffic occurs, the rate of inputting the burst flow exceeds the set bandwidth of the policer, tokens of the policer start to be consumed, and the amount of tokens accumulated in the policer is reduced. On the other hand, in the buffer, frames start to be accumulated and the amount of accumulated frames increases. At time indicated by (C) in FIG. 1B, the amount of tokens accumulated in the policer for the burst flow is 0.

After the amount of tokens accumulated in the policer becomes 0, if burst traffic input to the policer in a state in which the rate of inputting the burst flow exceeds the set bandwidth of the policer is discarded by the policer.

For example, in the example illustrated in FIG. 1B, if the first method is executed, the amount of frames accumulated in the buffer reaches the threshold, and the burst size of the policer for the burst flow is reduced at the time indicated by (C) in FIG. 1B. However, at the time indicated by (C) in FIG. 1B, the amount of tokens accumulated in the policer for the burst flow is 0 due to the burst traffic. Thus, even if the burst size (token upper limit) of the burst flow is reduced at the time indicated by (C) in FIG. 1B, the efficiency of suppressing the burst is likely to be low.

Before the time indicated by (C) in FIG. 1B, the burst traffic of the burst flow that has passed through the policer exists. The burst traffic that has passed through the policer is one of the reasons why the buffer is full of frames.

Thus, since it is too late to reduce the burst size of the policer after it is detected that the amount of frames accumulated in the buffer reaches the threshold like the first method, the buffer overflow is likely to occur.

In the embodiment, the timing of controlling the burst size of the policer is earlier than the first method. For example, the burst size of the policer is controlled before the start of the accumulation of frames in the buffer, for example. In the embodiment, the accumulation indicates that a state in which traffic in an amount exceeding the processing power of the buffer is input to the buffer continues for a predetermined time period and a state in which data exists in the buffer continues.

For example, in the example illustrated in FIG. 1A, the accumulation of the frames in the buffer starts at the time indicated by (B). Thus, in the embodiment, the start of the accumulation in the buffer is estimated by detecting characteristics of a change in the rate of inputting to the buffer before the time indicated by (B) illustrated in FIG. 1A. For example, as the characteristics of the change in the input rate before the start time, indicated by (B) in FIG. 1A, of the accumulation in the buffer, there are two characteristics, a first characteristic in which the ratio of the input rate to the reading bandwidth of the buffer is high and a second characteristic in which the input rate tends to increase.

Thus, in the embodiment, the burst size of the policer for the flow of the large amount of burst traffic is reduced by monitoring the rate of inputting to the buffer and by detecting that the rate of inputting to the buffer satisfies the first characteristic and the second characteristic.

Thus, before the start of the accumulation of frames in the buffer, the burst size of the policer for the flow of the large amount of burst traffic may be reduced. The reduction in the burst size before the start of the accumulation may suppress an increase in the rate of inputting to the buffer at earlier time and suppress the buffer overflow. The reduction in the burst size of the policer is an example of “control to be executed to suppress the flow of a data block into the buffer”.

A flow indicates a flow of multiple frames having common flow identification information, for example. As the flow identification information, any or a combination of a source Internet Protocol (IP) address, a destination IP address, a destination port number, and a source port number is used, for example. In the embodiment, information used as the flow identification information is not limited to specific information.

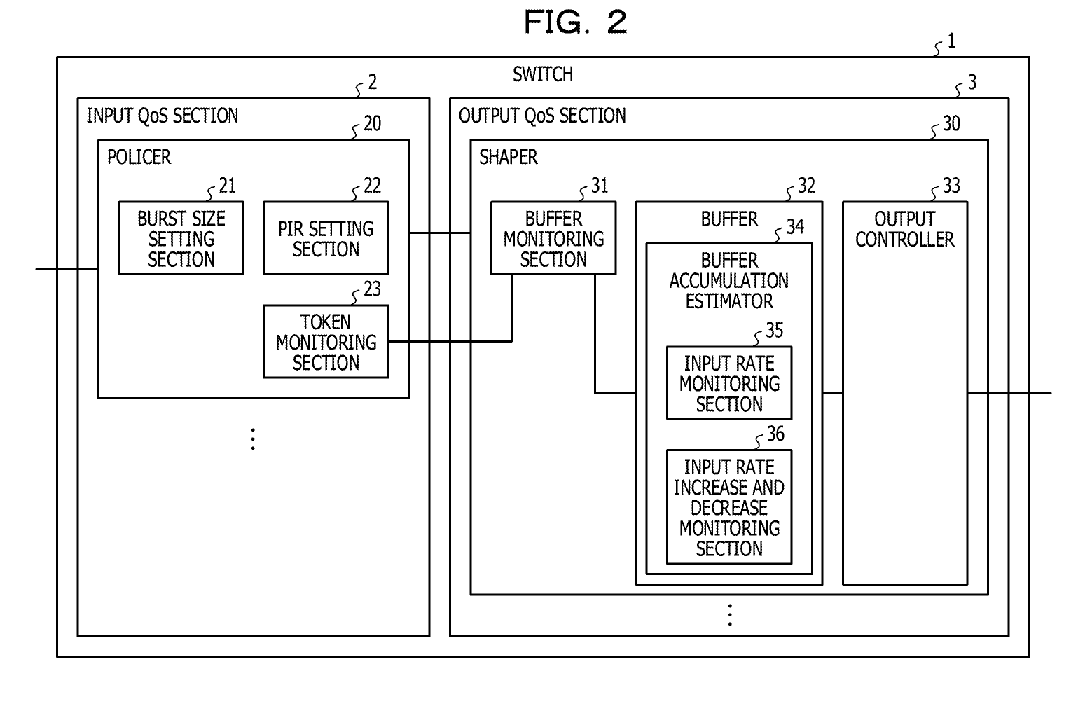

FIG. 2 is a diagram illustrating an example of a functional configuration of a switch 1 according to the embodiment. The switch 1 is, for example, a layer 2 switch. The switch 1 may be a chassis switch or a pizza box switch.

If the switch 1 is the chassis switch, the switch 1 includes multiple interface cards having multiple ports, a switch card for relaying between the multiple interface cards, and a control card for executing control (the cards are not illustrated). If the switch 1 is the pizza box switch, the switch 1 includes multiple ports, a switch section for relaying between the ports, and a controller for executing control (the ports, the switch section, and the controller are not illustrated).

The switch 1 is an example of an “information processing device”. The “information processing device” is not limited to the layer 2 switch and may be a layer 3 switch, a router, or the like.

The switch 1 includes an input Quality-of-Service (QoS) section 2 and an output QoS section 3 as functional constituent elements. The input QoS section 2 executes a QoS process for the input side of the switch 1. The output QoS section 3 executes a QoS process for the output side of the switch 1.

Each of the input QoS section 2 and the output QoS section 3 is a field-programmable gate array (FPGA), an application specific integrated circuit (ASIC), or a programmable logic device (PLD), for example. Alternatively, each of the input QoS section 2 and the output QoS section 3 may be a function achieved by causing a network processor to execute a predetermined program, for example.

For example, if the switch 1 is the chassis switch, a pair of the input QoS section 2 and the output QoS section 3 is installed for each of the interface cards. For example, if the switch 1 is the pizza box switch, the input QoS section 2 is installed on the input side of the ports and the output QoS section 3 is installed on the output side of the ports.

The input QoS section 2 includes the same number of policers 20 as the number of flows that are input to the interface cards or the switch 1. However, FIG. 2 illustrates only a single policer 20 for convenience sake. Each of the policers 20 executes policing on a target flow. Frames output from the policers 20 are input to shapers 30 by a switching card included in the switch 1 or by a switching section included in the switch 1. The shapers 30 are installed on the side of output ports for the frames.

In the policing by each of the policers 20, the following process is executed, for example. For example, if tokens exist in a token bucket (not illustrated), arriving frames are output. For example, if a token does not exist in the token bucket, a process of discarding arriving frames is executed. In the policing, tokens in an amount corresponding to the output frames are deleted from the token bucket. In the policing, a predetermined amount of tokens are added to the token bucket in each of predetermined time cycles.

Each of the policers 20 includes a burst size setting section 21, a peak information rate (PIR) setting section 22, and a token monitoring section 23. The burst size setting section 21 sets the burst size of the policer 20 or a token upper limit in accordance with an instruction from a buffer monitoring section 31 described later. The PIR setting section 22 sets the maximum information rate of a target flow. The burst size setting section 21 is an example of a “controller”.

The token monitoring section 23 monitors the amount of tokens accumulated in a token bucket and determines whether or not the target flow is a flow to be subjected to burst size control. The flow to be subjected to burst size control indicates a flow for which a burst size is to be reduced on a priority basis in the embodiment. The flow to be subjected to the burst size control is an example of a “flow satisfying a first requirement for determining that the flow includes burst traffic”.

If the token monitoring section 23 determines that the target flow is to be subjected to the burst size control, the token monitoring section 23 notifies information of the target flow to a buffer monitoring section 31 of a shaper 30 described later. A process, to be executed by the token monitoring section 23, of determining whether or not the target flow is the flow to be subjected to the burst size control is described later in detail. Whether or not a flow is to be subjected to the burst size control is an example of a “burst occurrence state”.

The output QoS section 3 includes the same number of shapers 30 as the number of flows that are output from interface cards included in the output QoS section 3 or from the switch 1. FIG. 2, however, illustrates only a single shaper 30 for convenience sake. Each of the shapers 30 executes shaping on a target flow.

In the shaping, the following process is executed, for example. For example, a shaper 30 outputs frames according to the token bucket scheme. Specifically, if tokens exist in a token bucket, arriving frames are output. In the output of the frame, tokens in an amount corresponding to the output frames are deleted from the token bucket. For example, in the shaping, if a token does not exist in the token bucket, an arriving frame stands by until a token is added to the token bucket. The addition, deletion, and the like of a token in the shaping is the same as or similar to those in the policing by each of the policers.

Each of the shapers 30 includes a buffer monitoring section 31, a buffer 32, and an output controller 33. The buffer 32 temporality accumulates frames of multiple flows output from the multiple policers 20. The output controller 33 uses a token bucket for the shaper 30 to read a frame from the buffer 32 at the reading bandwidth of the buffer and output the read frame. The buffer 32 is an example of a “buffer that stores data blocks of multiple flows and from which the data blocks are sequentially read” or a “buffer that collects data blocks output from multiple policers and outputs the data blocks”.

The buffer 32 includes a buffer accumulation estimator 34. The buffer accumulation estimator 34 collects information to be used to estimate the start of the accumulation of frames in the buffer 32. The buffer accumulation estimator 34 includes an input rate monitoring section 35 and an input rate increase and decrease monitoring section 36. The input rate monitoring section 35 monitors the amount of traffic input to the buffer 32 per unit of time or monitors the rate of inputting to the buffer 32. A process to be executed by the input rate monitoring section 35 is described later in detail.

The input rate increase and decrease monitoring section 36 monitors an increasing or decreasing trend in the amount of traffic input to the buffer 32 per unit of time or monitors an inclination of the rate of inputting to the buffer 32. A process to be executed by the input rate increase and decrease monitoring section 36 is described later in detail. The inclination of the rate of inputting to the buffer 32 is an example of an “increasing or decreasing trend in the input rate”.

The buffer accumulation estimator 34 acquires the result of monitoring the rate of inputting to the buffer 32 from the input rate monitoring section 35, acquires the result of monitoring the inclination of the rate of inputting to the buffer 32 from the input rate increasing and decreasing monitoring section 36, and notifies the acquired results to the buffer monitoring section 31 in each of predetermined time cycles. The cycles in which the buffer accumulation estimator 34 notifies, to the buffer monitoring section 31, the result of monitoring the rate of inputting to the buffer 32 and the result of monitoring the inclination of the rate of inputting to the buffer 32 are set to 1 microsecond, for example.

The buffer accumulation estimator 34 monitors the amount of frames accumulated in the buffer 32. The amount of frames accumulated in the buffer 32 is hereinafter referred to as amount used by the buffer 32 or buffer usage amount. The buffer accumulation estimator 34 holds, in a register or the like, a burst size restoration threshold to be used to determine whether or not the burst size of a policer 20 for a flow whose burst size has been reduced is to be restored to an initial value. The buffer accumulation estimator 34 notifies the result of comparing the amount used by the buffer 32 with the burst size restoration threshold to the buffer monitoring section 31 in each of predetermined time cycles. The burst size restoration threshold is an example of a “third threshold”.

The cycles in which the result of comparing the amount used by the buffer 32 with the burst size restoration threshold is notified are set to 1 microsecond, for example. The result of comparing the amount used by the buffer 32 with the burst size restoration threshold may be notified together with a notification indicating information of the rate of inputting to the buffer 32 and the inclination of the rate of inputting to the buffer 32 or may be notified at different time from the notification indicating the information of the rate of inputting to the buffer 32 and the inclination of the rate of inputting to the buffer 32.

The buffer monitoring section 31 receives, from the buffer accumulation estimator 34, a notification indicating the result of monitoring the rate of inputting to the buffer 32 and the result of monitoring the inclination of the rate of inputting to the buffer 32 in each of predetermined cycles. The buffer monitoring section 31 estimates the start of the accumulation of frames in the buffer 32 based on the result of monitoring the rate of inputting to the buffer 32 and the result of monitoring the inclination of the rate of inputting to the buffer 32.

The buffer monitoring section 31 receives, from the token monitoring sections 23 of the policers 20, notifications indicating information of flows to be subjected to the burst size control. If the buffer monitoring section 31 has estimated the start of the accumulation of frames in the buffer 32, the buffer monitoring section 31 reduces burst sizes of the flows that that have been notified from the token monitoring sections 23 of the policers 20 and are among flows input to the buffer 32 and are to be subjected to the burst size control.

The buffer monitoring section 31 receives a notification indicating the amount used by the buffer 32 from the buffer accumulation estimator 34 in each of predetermined cycles. The buffer monitoring section 31 controls the burst size of a flow for which the burst size is being reduced so that the burst size of the flow is restored to a predetermined value, based on the rate of inputting to the buffer 32, the inclination of the rate of inputting to the buffer 32, and the buffer usage amount. A process to be executed by the buffer monitoring section 31 is described later in detail. The buffer monitoring section 31 is an example of a “monitoring section”.

Details of Process to be Executed by Token Monitoring Section

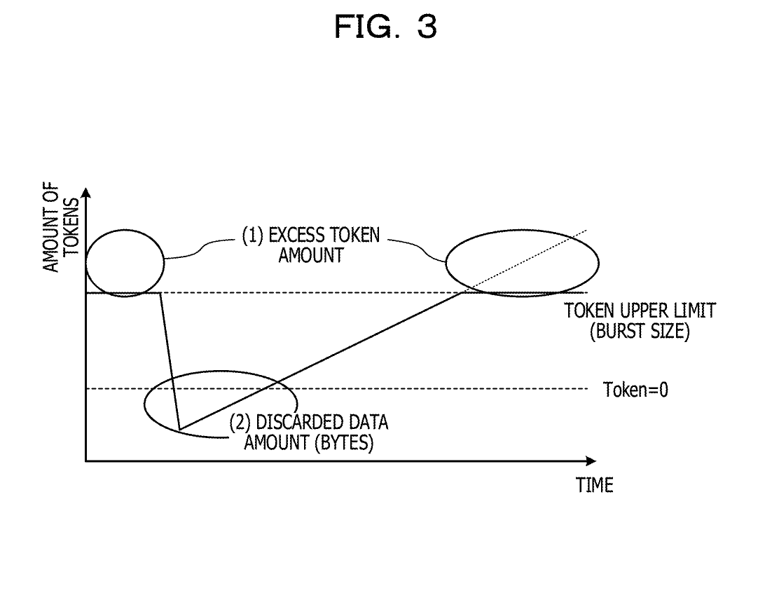

FIG. 3 is a diagram illustrating an example of a change in the amount of tokens accumulated in a token bucket of a policer 20. A predetermined amount of tokens are added to the token bucket in each of predetermined cycles. The cycles in which the predetermined amount of tokens are added to the token bucket are hereinafter referred to as token addition cycles. The token addition cycles are set to 1 millisecond, for example.

As indicated by (1) in FIG. 3, if the amount of tokens accumulated in the token bucket already reaches a token upper limit, a token added to the token bucket in a predetermined cycle is discarded. The amount of a token added to the token bucket in a state in which the amount of tokens accumulated in the token bucket exceeds the token upper limit is hereinafter referred to as excess token amount (1).

When frames are output from a policer 20, tokens in an amount corresponding to the output frames are deleted from the token bucket. As indicated by (2) in FIG. 3, if the amount of tokens accumulated in the token bucket is 0, a frame input to the policer 20 is discarded. The amount of data of a frame discarded due to a lack of tokens in the token bucket is hereinafter referred to as discarded data amount (2). The discarded data amount (2) is expressed in bytes, for example. The discarded data amount (2), however, is not limited to this and may be expressed in bits.

The token monitoring section 23 monitors a change in the amount of tokens included in the token bucket, as described above. Then, the token monitoring section 23 determines whether or not a target flow input to the policer 20 including the token monitoring section 23 is to be subjected to the burst size control. Details are described below, for example.

First Method for Determining Flow to be Subjected to Control

The token monitoring section 23 executes calculation to subtract the excess token amount (1) from the discarded data amount (2) for each of the token addition cycles and calculates a moving average of the results of the calculation executed a number n (n is a positive integer) of times in the latest past. If a burst occurs, the discarded data amount (2) is large and the excess token amount (1) is infinitesimally close to 0. If the value of the moving average of the calculation results exceeds a threshold, the token monitoring section 23 determines that the target flow is to be subjected to the burst size control.

Second Method for Determining Flow to be Subjected to Control

The token monitoring section 23 calculates the discarded data amount (2) for each of the token addition time cycles and calculates a moving average of the results of the calculation executed a number n (n is a positive integer) of times in the latest past. If a burst occurs, the discarded data amount (2) is large. If the value of the moving average of the calculation results exceeds a threshold, the token monitoring section 23 determines that the target flow is to be subjected to the burst size control.

Third Method for Determining Flow to be Subjected to Control

The token monitoring section 23 counts the number of times that a frame has been discarded in each of the token addition cycles. The token monitoring section 23 adds the number of times that a frame has been discarded for each time period of, for example, 1 second, and the token monitoring section 23 calculates a moving average of the numbers of times that a frame has been discarded for n seconds in the latest past. For example, in a token addition cycle, if the discarded data amount (2) is larger than 0, the number of times that a frame has been discarded is counted to 1. If a burst occurs, the number of times that a frame has been discarded for a time period of 1 second is large. If the moving average of the numbers of times that a frame has been discarded exceeds a threshold, the token monitoring section 23 determines that the target flow is to be subjected to the burst size control.

A burst time period within a predetermined time period may be calculated using the number of times that a frame has been discarded in each token addition cycle. For example, a burst time period within a time period of 1 second is obtained by multiplying a token addition cycle by the number of times that a frame has been discarded for a time period of 1 second. If the burst time period within the predetermined time period exceeds a threshold, the token monitoring section 23 may determine that the target flow is to be subjected to the burst size control.

Fourth Method for Determining Flow to be Subjected to Control

The token monitoring section 23 calculates, as a burst consumption ratio, the ratio of the amount of accumulated tokens to a token upper limit. Then, if a moving average of the burst consumption ratio for the latest past predetermined time period is lower than a threshold, the token monitoring section 23 determines that the target flow is to be subjected to the burst size control. If a burst occurs, a token a consumed and the burst consumption ratio is close to 0.

The determination of whether or not the target flow is to be subjected to the burst size control may be made using any of the aforementioned first to fourth methods for determining the flow to be subjected to the control or using two or more of the aforementioned first to fourth methods. Methods for determining whether or not the target flow is to be subjected to the burst size control are not limited to the aforementioned first to fourth methods for determining the flow to be subjected to the control. The requirements for determining that the target flow is to be subjected to the control in the aforementioned first to fourth methods for determining the flow to be subjected to the control are examples of the “first requirement for determining that the flow includes burst traffic”.

Each of the moving averages used in the aforementioned first to third methods for determining a flow to be subjected to the control is not limited to any of a simple moving average, a weighted moving average, and the like and may be any of moving averages.

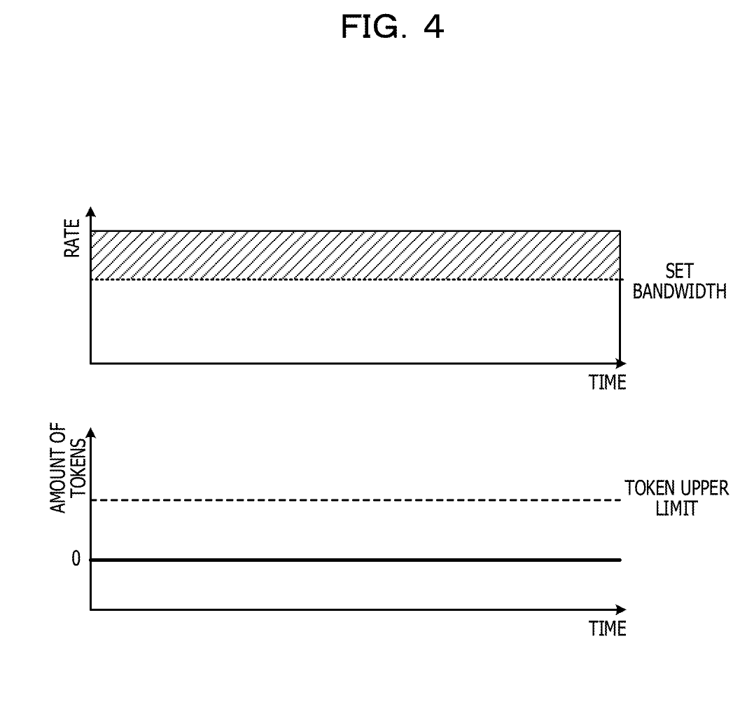

FIGS. 4, 5, and 6 are diagrams illustrating examples of traffic of flows to be subjected to the burst size control. Each of graphs illustrated on upper sides of FIGS. 4 to 6 indicates an example of a change in the rate of inputting a flow to be subjected to the burst size control. Each of graphs illustrated on lower sides of FIGS. 4 to 6 indicates an example of a change in the amount of tokens accumulated in a token bucket in the case where traffic of a flow indicated by each of the graphs illustrated on the upper sides is input to a policer 20.

FIG. 4 illustrates an example of traffic of a flow input to the policer 20 at a rate exceeding the set bandwidth of the policer 20. Traffic input to the policer 20 in a state in which the rate of inputting a flow of the traffic exceeds the set bandwidth of the policer 20 is discarded. The set bandwidth of the policer 20 is, for example, a committed information rate (CIR).

In the case where the traffic of the flow is input to the policer 20 at a rate exceeding the set bandwidth of the policer 20, the amount of tokens accumulated in the token bucket of the policer 20 is equal to or close to 0, as indicated by the graph illustrated on the lower side of FIG. 4. Specifically, even if a token is added to the token bucket in a token addition cycle, the token is immediately consumed, the amount of tokens is insufficient, and data is discarded.

Thus, if the flow is continuously input to the policer 20 at a rate exceeding the set bandwidth of the policer 20 as illustrated in FIG. 4, the determination of whether or not the target flow is to be subjected to the burst size control may be made using the third method for determining a flow to be subjected to the control. The third method for determining a flow to be subjected to the control uses the number of times that a frame has been discarded in each of the token addition cycles.

For example, in the third method for determining a flow to be subjected to the control, the token monitoring section 23 adds 1 to the number of times that a frame has been discarded in token addition cycles for each of time periods of 1 second. If a moving average of the numbers of times that a frame has been discarded for the latest past time period of 1 minute is calculated, the moving average of the numbers of times that a frame has been discarded is expressed by the following Equation 1. In this case, a threshold for the moving average of the numbers of times that a frame has been discarded is the number (=(1 second/a token addition cycle)×α(0<α≤1)) of times that a token is added for a time period of 1 second, for example. The threshold is used to determine whether or not the target flow is to be subjected to the control.

$$M 3 ( n ) = \frac{n - 1}{n} \times M 3 ( n - 1 ) + \frac{1}{n} \times m 3 \qquad ( Equation 1 )$$

In Equation 1, n is a variable defining a time period (of seconds) for the calculation of the moving average, M3(n) is a moving average of the numbers of times that a frame has been discarded in target token addition cycles, and M3(n−1) is a moving average of the numbers of times that a frame has been discarded in token addition cycles starting 1 second before the start of the target token addition cycles, and m3 is the number of times that a frame has been discarded in the target token addition cycles for a time period of 1 second.

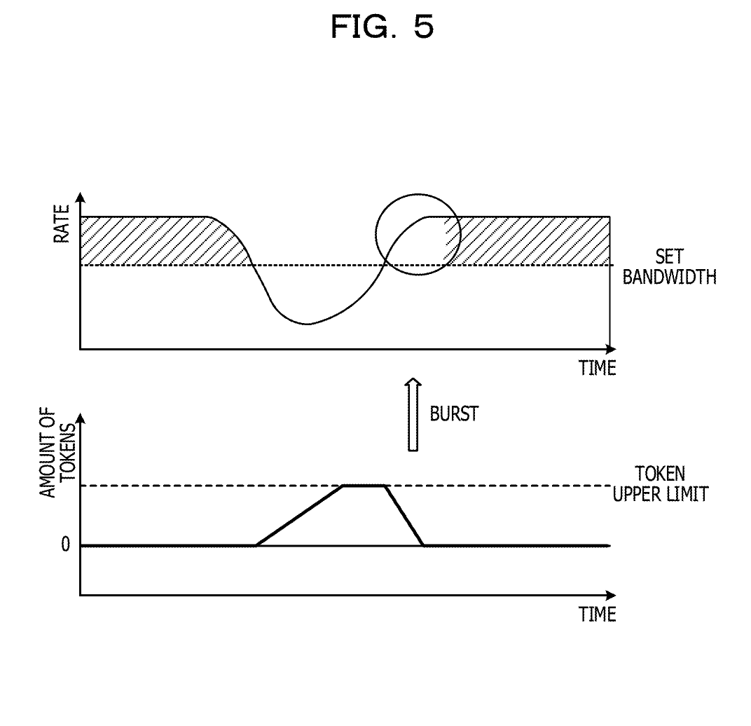

FIG. 5 illustrates an example of traffic of a flow input to the policer 20 at a rate that becomes lower than the set bandwidth of the policer 20 at a low frequency. If the traffic of the flow is input to the policer 20 at the rate that becomes lower than the set bandwidth of the policer 20 at the low frequency, during the time when the rate of inputting the flow is lower than the set bandwidth, a token is accumulated in the token bucket of the policer 20, but the ratio of a time period during which the amount of tokens accumulated in the token bucket is equal to or close to 0 is high, as indicated by a graph illustrated on the lower side of FIG. 5.

If the flow is input to the policer 20 at the rate that becomes lower than the set bandwidth of the policer 20 at the low frequency as illustrated in FIG. 5, the determination of whether or not the target flow is to be subjected to the burst size control may be made using the fourth method for determining a flow to be subjected to the control. The fourth method for determining a flow to be subjected to the control uses a burst consumption ratio that is the ratio of the amount of tokens accumulated in the token bucket to a token upper limit of the token bucket.

For example, in the fourth method for determining a flow to be subjected to the control, a moving average of the burst consumption ratio is expressed by the following Equation 2. A threshold for the moving average of the burst consumption ratio is set to a value that is equal to or close to 0 and is, for example, equal to or smaller than 0.1 or the like, since 0≤the burst consumption ratio≤1. The threshold for the moving average of the burst consumption ratio is used to determine whether or not the target flow is to be subjected to the control.

$$M 4 ( n ) = \frac{n - 1}{n} \times M 4 ( n - 1 ) + \frac{1}{n} \times m 4 \qquad ( Equation 2 )$$

In Equation 2, n is a variable defining a time period for the calculation of the moving average (the time period for the calculation of the moving average=a token addition cycle×α), M4(n) is the moving average of the burst consumption ratio, M4(n−1) is a moving average of the burst consumption ratio in a previous token addition cycle, and m4 is the ratio of a current amount of tokens accumulated in the token bucket with respect to the token upper limit (or the current burst consumption ratio).

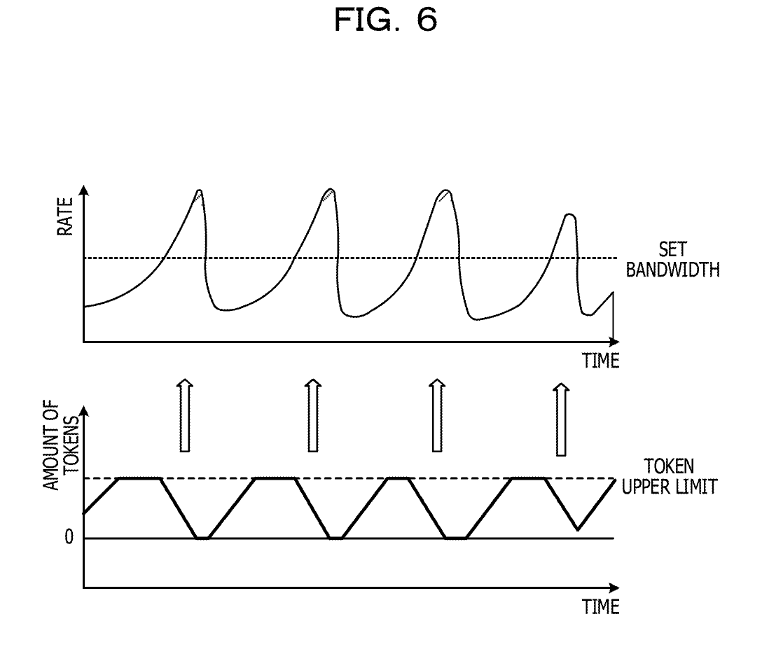

FIG. 6 illustrates an example of traffic of a flow that is input to the policer 20 at a rate that alternately becomes lower than the set bandwidth of the policer 20 and becomes higher than the set bandwidth of the policer 20. The flow that is input to the policer 20 at the rate that alternately becomes lower than the set bandwidth of the policer 20 and becomes higher than the set bandwidth of the policer 20 is a Transmission Control Protocol (TCP) flow in many cases, for example. If the traffic of the flow is input to the policer 20 at the rate that alternately becomes lower than the set bandwidth of the policer 20 and becomes higher than the set bandwidth of the policer 20, the amount of accumulated tokens alternately changes to 0 and to the token upper limit, as indicated by a graph illustrated on the lower side of FIG. 6.

Thus, if the traffic of the flow is input to the policer 20 at the rate that alternately becomes lower than the set bandwidth of the policer 20 and becomes higher than the set bandwidth of the policer 20 as illustrated in FIG. 6, the determination of whether or not the target flow is to be subjected to the burst size control may be made using the fourth method for determining a flow to be subjected to the control, for example. The fourth method for determining a flow to be subjected to the control uses a burst consumption ratio that is the ratio of the amount of accumulated tokens to the token upper limit. A threshold for a moving average of the burst consumption ratio is set to a value in a range of 0.3 to 0.8 or the like, since 0≤the burst consumption ratio≤1. The threshold for the moving average of the burst consumption ratio is used to determine whether or not the target flow is subjected to be the control.

The third or fourth method for determining a flow to be subjected to the control is used in each of the examples illustrated in FIGS. 4 to 6. However, in each of the examples illustrated in FIGS. 4 to 6, the method for determining a flow to be subjected to the control is not limited to the third or fourth method for determining a flow to be subjected to the control. For example, if traffic illustrated in each of FIGS. 4 to 6 is input to the policer 20, any of the first and second methods for determining a flow to be subjected to the control may be used.

Details of Process to be Executed by Input Rate Monitoring Section

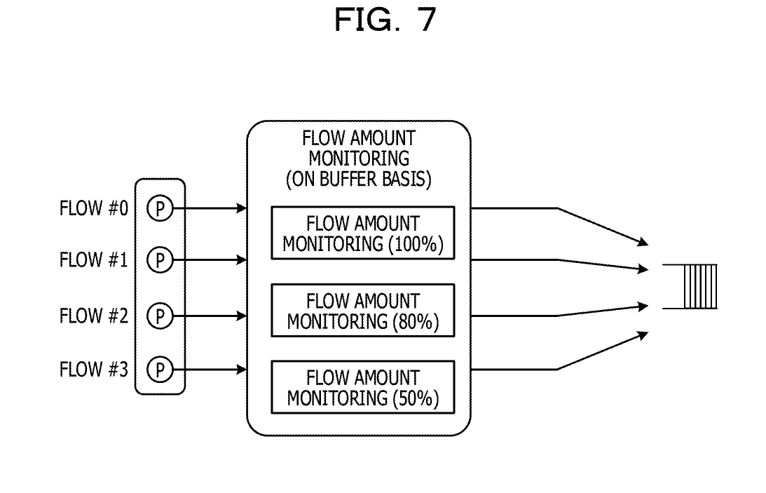

FIG. 7 is a diagram illustrating an example of a method for monitoring the input rate by the input rate monitoring section 35 according to the embodiment. Frames of multiple flows are input to the buffer 32 from the multiple policers 20. The input rate monitoring section 35 monitors the total of the rates of inputting all the flows to the buffer 32.

The method for monitoring the input rate by the input rate monitoring section 35 is as follows, for example. The input rate monitoring section 35 includes token buckets for multiple rates to be measured in order to monitor the total of the rates of inputting traffic of all the flows to the buffer 32, and the token buckets are installed on the upstream side of the buffer 32. For example, if it is detected that the rate of inputting to the buffer 32 has reached each of 50%, 80%, and 100% of the reading bandwidth of the buffer 32, the input rate monitoring section 35 includes three token buckets for the detection of the rates of 50%, 80%, and 100% of the reading bandwidth of the buffer 32. Token addition cycles and the amount of tokens to be added are set in each of the token buckets based on the rates to be detected.

The input rate monitoring section 35 monitors the rate of inputting to the buffer 32 based on whether or not the token buckets for the detection of the rates become empty. For example, if all the token buckets for the detection of the rates of 50%, 80%, and 100% are not empty, the input rate monitoring section 35 detects that the rate of inputting to the buffer 32 is equal to or lower than the rate of 50% of the reading bandwidth of the buffer 32. For example, if the token bucket for the detection of the rate of 50% is empty and the other token bucket are not empty, the input rate monitoring section 35 detects that the rate of inputting to the buffer 32 is higher than the rate of 50% of the reading bandwidth of the buffer 32 and equal to or lower than the rate of 80% of the reading bandwidth of the buffer 32.

If the token buckets for the detection of the rates of 50% and 80% are empty and the token bucket for the detection of the rate of 100% is not empty, the input rate monitoring section 35 detects that the rate of inputting to the buffer 32 is higher than the rate of 80% of the reading bandwidth of the buffer 32 and equal to or lower than the rate of 100% of the reading bandwidth of the buffer 32. If all the token buckets for the detection of the rates of 50%, 80%, and 100% are empty, the input rate monitoring section 35 detects that the rate of inputting to the buffer 32 is higher than the rate of 100% of the reading bandwidth of the buffer 32.

Specifically, if the input rate monitoring sections 35 includes the token buckets for the detection of the rates of 50%, 80%, and 100%, the result of monitoring the rate of inputting to the buffer 32 indicates that the rate of inputting to the buffer 32 is equal to or lower than the rate of 50% of the reading bandwidth of the buffer 32, or is higher than the rate of 50% of the reading bandwidth of the buffer 32 and equal to or lower than the rate of 80% of the reading bandwidth of the buffer 32, or is higher than the rate of 80% of the reading bandwidth of the buffer 32 and equal to or lower than the rate of 100% of the reading bandwidth of the buffer 32, or is higher than the rate of 100% of the reading bandwidth of the buffer 32.

The token buckets included in the input rate monitoring section 35 are used to monitor the rate of inputting to the buffer 32. Even if the amount of tokens accumulated in the token buckets included in the input rate monitoring section 35 is 0, a frame is not discarded. Regarding the token buckets included in the input rate monitoring section 35, the ratios of rates of inputting to the buffer 32 with respect to the reading bandwidth of the buffer 32 are not limited to the three percentages, 50%, 80%, and 100%.

The number of token buckets included in the input rate monitoring section 35 and rates to be detected using the token buckets or the ratios of rates of inputting to the buffer 32 with respect to the reading bandwidth of the buffer may be arbitrarily set by an administrator of the switch 1. The rates to be detected using the token buckets included in the input rate monitoring section 35 are not limited to the ratios of rates of inputting to the buffer 32 with respect to the reading bandwidth of the buffer 32 and may be directly set. As the rates to be detected using the token buckets included in the input rate monitoring section 35, rates may be directly set. As the rates to be detected using the token buckets included in the input rate monitoring section 35, values equal to or higher than the reading bandwidth of the buffer 32 may be set. Specifically, the ratio of the rate of inputting to the buffer 32 with respect to the reading bandwidth of the buffer 32 may be set to a ratio equal to or higher than 100%.

A method for monitoring the rate of inputting to the buffer 32 is not limited to the example illustrated in FIG. 7. For example, the amount of traffic input to the buffer 32 in each of predetermined cycles may be recorded in a memory, the amount of traffic input per unit of time in the latest past may be calculated, and the rate of inputting to the buffer 32 may be directly calculated.

Details of Process to be Executed by Input Rate Increase and Decrease Monitoring Section

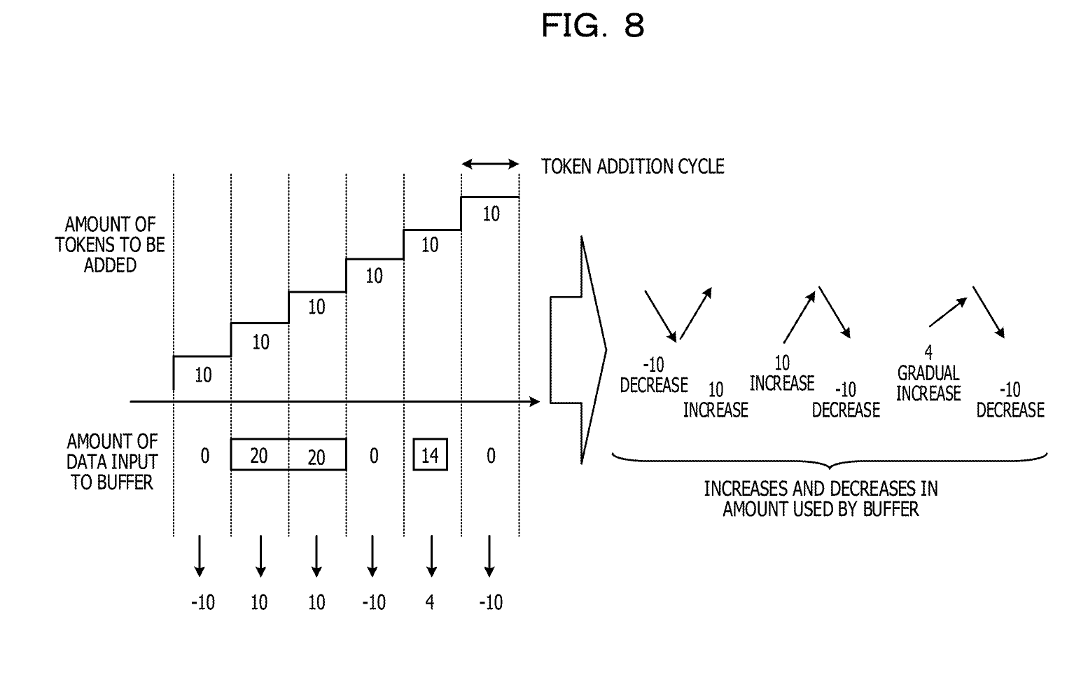

FIG. 8 is a diagram illustrating an example of a method for monitoring the inclination of the input rate by the input rate increase and decrease monitoring section 36 according to the embodiment.

If the input rate is monitored using the method described with reference to FIG. 7, the value of the input rate is not directly calculated and an increase or decrease in the input rate may not be directly acquired. For example, there are correlation relationships between increases and decreases in the input rate and increases and decreases in the amount used by the buffer, as illustrated in FIG. 3. The correlation relationships between increases and decreases in the input rate and increases and decreases in the amount used by the buffer indicate that when the input rate increases, the amount used by the buffer increases after a predetermined time lag, and that when the input rate decreases, the amount used by the buffer decreases after a predetermined time lag, for example.

Thus, if the amount used by the buffer is monitored, increases and decreases in the input rate may be estimated. If the input rate is monitored using the method described with reference to FIG. 7, the input rate increase and decrease monitoring section 36 estimates an increase or decrease in the input rate by monitoring the amount used by the buffer.

Specifically, the input rate increase and decrease monitoring section 36 acquires the difference between the amount of data input to the buffer 32 and the amount of tokens to be added for each of token addition cycles of the token bucket used for the detection of the rate of 100% and included in the input rate monitoring section 35. This is due to the fact that, in the token bucket used for the detection of the rate of 100% and included in the input rate monitoring section 35, the token upper limit and the token addition time cycles are set based on the reading bandwidth of the buffer 32.

The difference between the amount of data input to the buffer 32 and the amount of added tokens corresponds to a value by which the amount used by the buffer 32 increases or decreases in each of the token addition cycles of the token bucket for the detection of the rate of 100%. The example illustrated in FIG. 8 indicates the case where the amount of tokens to be added in each token addition cycle is 10.

For example, if the amount of data input to the buffer 32 is 0, the difference between the amount of the data input to the buffer 32 and the amount of added tokens is −10, which indicates that the amount used by the buffer 32 decreases. If the difference indicates that the amount used by the buffer 32 decreases, the difference indicates that the rate of inputting to the buffer 32 also decreases.

For example, if the amount of data input to the buffer 32 is 20, the difference between the amount of the data input to the buffer 32 and the amount of the added tokens is +10, which indicates that the amount used by the buffer 32 increases. If the difference indicates that the amount used by the buffer 32 increases, the difference indicates that the rate of inputting to the buffer 32 also increases.

For example, if the amount of data input to the buffer 32 is 10, the difference between the amount of the data input to the buffer 32 and the amount of the added tokens is 0, which indicates that the amount used by the buffer 32 does not change. If the difference indicates that the amount used by the buffer 32 does not change, the difference indicates that the rate of inputting to the buffer 32 also does not change or is maintained.

If the difference between the amount of data input to the buffer 32 and the amount of the added tokens is positive, the input rate increase or decrease monitoring section 36 determines that the result of monitoring the inclination of the input rate is positive. If the difference between the amount of the data input to the buffer 32 and the amount of the added tokens is negative, the input rate increase or decrease monitoring section 36 determines that the result of monitoring the inclination of the input rate is negative. If the difference between the amount of the data input to the buffer 32 and the amount of the added token is 0, the input rate increase or decrease monitoring section 36 determines that the result of monitoring the inclination of the input rate is 0.

The fact that the result of monitoring the inclination of the input rate is positive is an example of an “increasing trend in the input rate”. The fact that the result of monitoring the inclination of the input rate is negative is an example of a “decreasing trend in the input rate”. The fact that the result of monitoring the inclination of the input rate is 0 is an example of a “maintained trend in the input rate”.

The buffer accumulation estimator 34 acquires the result of monitoring the input rate from the input rate monitoring section 35 and the result of monitoring the inclination of the input rate from the input rate increase and decrease monitoring section 36 and notifies the acquired results to the buffer monitoring section 31 for each of the token addition cycles of the token bucket included in the input rate monitoring section 35 and used for the detection of the rate of 100%. Instead of the token bucket included in the input rate monitoring section 35 and used for the detection of the rate of 100%, cycles in which data is read from the buffer 32 of the output controller 33 operating at the reading bandwidth of the buffer 32, and the amount of the read data may be used.

A method for monitoring an increase and decrease in the input rate is not limited to the method described with reference to FIG. 8. For example, if the input rate is directly calculated, the result of calculating the input rate may be recorded in a memory or the like, and an increase and decrease in the input rate may be monitored.

Details of Process to be Executed by Buffer Monitoring Section

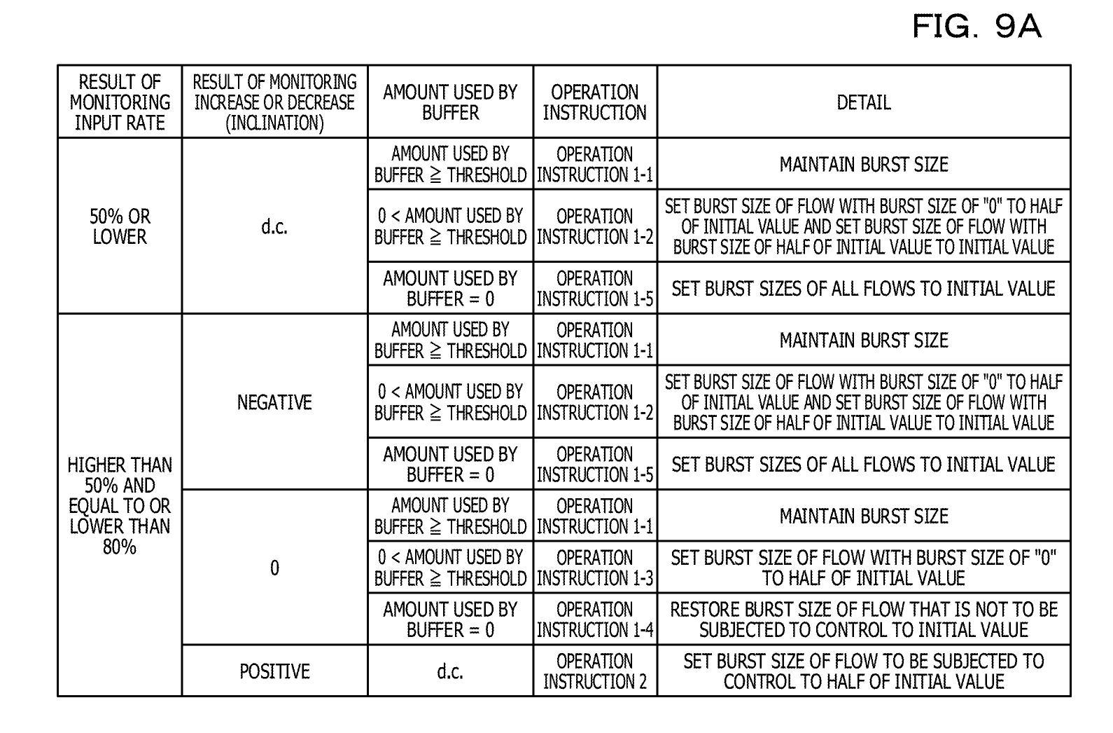

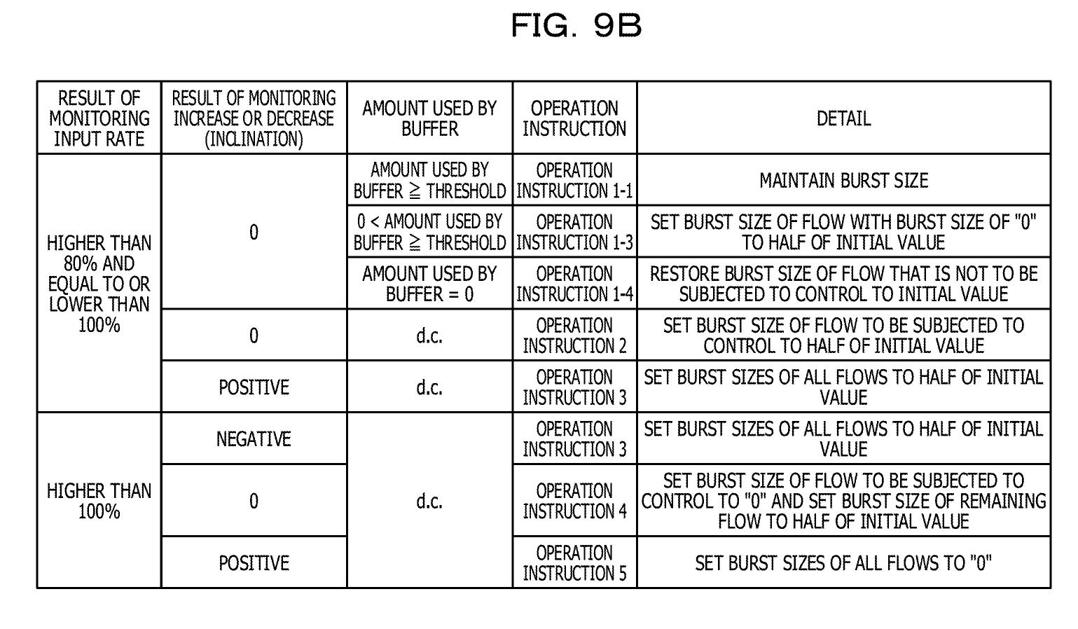

FIGS. 9A and 9B are tables illustrating an example of details of the burst size control by the buffer monitoring section 31 according to the embodiment. The buffer monitoring section 31 receives, from the buffer accumulation estimator 34, a notification indicating the results of monitoring the rate of inputting to the buffer 32, the results of monitoring the inclination of the rate of inputting to the buffer 32, and the results of comparing the amount used by the buffer 32 with the burst size restoration threshold. The buffer monitoring section 31 receives, from the token monitoring sections 23 of the policers 20, notifications indicating information of flows to be subjected to the burst size control.

The tables illustrated in FIGS. 9A and 9B illustrate an example of details of a process executed by the buffer monitoring section 31 based on the results of monitoring the rate of inputting to the buffer 32, the results of monitoring the inclination of the rate of inputting to the buffer 32, and the results of comparing the amount used by the buffer 32 with the burst size restoration threshold. “d.c.” indicated in the table illustrated in FIG. 9A is an abbreviation of “don't care” and indicates an arbitrary value within each of items included in the table and indicating “d.c.”. Flows indicated in the table illustrated in FIG. 9A indicate flows that will be input to the buffer 32.

In the example illustrated in FIGS. 9A and 9B, the details of the process executed by the buffer monitoring section 31 are defined by operation instructions 1-1 to 1-5 and operation instructions 2 to 5. The operation instructions 1-1 to 1-5 indicate processes of increasing the reduced burst size of a flow or restoring the reduced burst size of a flow to the initial value. The processes of increasing the reduced burst size of a flow or restoring the reduced burst size of a flow to the initial value are examples of “control to be executed to promote a data block to flow into a buffer”.

A detail of the operation instruction 1-1 is to inhibit the burst size of any flow that will be input to the buffer 32 from changing. A detail of the operation instruction 1-2 is to set the burst size of a flow with a burst size of “0” to half of the initial value and to restore the burst size of a flow with a burst size of half of the initial value to the initial value. The burst size of “0” indicates the stop of the input of a flow to the buffer 32. Specifically, the burst size of “0” indicates that all frames of the flow with a burst size of “0” are discarded by a corresponding policer 20.

Setting the burst size of a flow with a burst size of “0” to half of the initial value and restoring the burst size of a flow with a burst size of half of the initial value to the initial value are examples of “control to be executed to promote a data block to flow into the buffer for one or more of flows for which the flow of a data block into the buffer is suppressed”. Setting the burst size of a flow with a burst size of “0” to half of the initial value is an example of “control to be executed to cancel the stop of the flow of a data block into the buffer and promote the data block to flow into the buffer for the flow for which the flow of the data block into the buffer is stopped”.

A detail of the operation instruction 1-3 is to set the burst size of a flow with a burst size of “0” to half of the initial value. A detail of the operation instruction 1-4 is to restore the burst size of a flow that is not to be subjected to the control to the initial value. A detail of the operation instruction 1-5 is to set burst sizes of all flows that will be input to the buffer 32 to the initial value.

The operation instructions 2 to 5 are processes of reducing a burst size. A detail of the operation instruction 2 is to set the burst size of a flow to be subjected to the control to half of the initial value. A detail of the operation instruction 3 is to set burst sizes of all flows that will be input to the buffer 32 to half of the initial value.

A detail of the operation instruction 4 is set the burst size of a flow to be subjected to the control to 0 and set the burst size of a flow that is not to be subjected to the control to half of the initial value. A detail of the operation instruction 5 is to set burst sizes of all flows that will be input to the buffer 32 to 0.

Although the detail of the operation instruction 5 is to set burst sizes of all flows that will be input to the buffer 32 to 0, the detail of the operation instruction 5 is not limited to this. For example, the detail of the operation instruction 5 may be to set the burst size of a flow to be subjected to the control to “0” and set the burst size of a flow that is not subjected to the control to the same size as the amount of tokens to be added in a single token addition cycle. In this case, if traffic of a flow that is not to be subjected to the control is input to a policer at a rate equal to or lower than the set bandwidth of the policer, the traffic passes through the policer, but if a flow that is not to be subjected to the control has burst traffic, the burst traffic does not pass through the policer.

Setting a burst size to half of the initial value and setting a burst size to “0” are examples of the “suppression of the flow of a data block into the buffer”. Setting a burst size to “0” is an example of the “stop of the flow of a data block into the buffer”.

In order to change the burst size of a flow, the buffer monitoring section 31 notifies an instruction to change the burst size to a burst size setting section 21 of a policer 20 corresponding to the flow with the burst size to be changed.

For example, in the example illustrated in FIG. 9A, it is defined that if the rate of inputting to the buffer 32 is equal to or lower than 50% and the amount used by the buffer 32 is equal to or larger than the burst size restoration threshold, the buffer monitoring section 31 executes the process of the operation instruction 1-1. Specifically, the burst size of any flow is not changed. This is due to the fact that the amount used by the buffer 32 is large regardless of the relatively low rate of inputting to the buffer 32. For example, this is due to the fact that if the burst size of any flow is restored or a burst occurs in any flow, the buffer overflow is likely to occur.

For example, in the example illustrated in FIG. 9A, it is defined that if the rate of inputting to the buffer 32 is equal to or lower than 50% and the amount used by the buffer 32 is larger than 0 and smaller than the burst size restoration threshold, the buffer monitoring section 31 executes the process of the operation instruction 1-2. Specifically, the burst size of a flow with a burst size of “0” is changed to half of the initial value, and the burst size of a flow with a burst size of half of the initial value is restored to the initial value. This is due to the fact that the rate of inputting to the buffer 32 is relatively low and the buffer 32 has a sufficiently available region. In this case, the reason why burst sizes of one or more flows are not restored to the initial value is that, for example, a burst may occur in a flow to be subjected to the control.

For example, in the example illustrated in FIG. 9A, it is defined that if the rate of inputting to the buffer 32 is equal to or lower than 50% and the amount used by the buffer 32 is 0, the buffer monitoring section 31 executes the process of the operation instruction 1-5. Specifically, burst sizes of all flows are restored to the initial value. This is due to the fact that the rate of inputting to the buffer 32 is relatively low and the buffer 32 is empty. For example, even if a burst occurs in any flow, the buffer overflow is unlikely to occur.

For example, in the example illustrated in FIG. 9A, it is defined that if the rate of inputting to the buffer 32 is higher than 50% and equal to or lower than 80%, the inclination of the input rate is negative or 0, and the amount used by the buffer 32 is equal to or larger than the burst size restoration threshold, the buffer monitoring section 31 executes the process of the operation instruction 1-1. Specifically, the burst size of any flow is not changed. This is due to the fact that the amount used by the buffer 32 is large regardless of a decreasing trend in the rate of inputting to the buffer 32, and if the burst size of any flow is restored or a burst occurs in any flow, the buffer overflow is likely to occur.

For example, in the example illustrated in FIG. 9A, it is defined that if the rate of inputting to the buffer 32 is higher than 50% and equal to or lower than 80%, the inclination of the input rate is negative, and the amount used by the buffer 32 is larger than 0 and smaller than the burst size restoration threshold, the buffer monitoring section 31 executes the process of the operation instruction 1-2. Specifically, the burst size of a flow with a burst size of “0” is changed to half of the initial value, and the burst size of a flow with a burst size of half of the initial value is restored to the initial value. This is due to the fact that since the rate of inputting to the buffer 32 is relatively high, the buffer 32 has a sufficiently available region, and the input rate tends to decrease, the amount used by the buffer 32 is likely to decrease. In this case, the reason why burst sizes of one or more of all flows are not restored to the initial value is that, for example, a burst may occur in a flow to be subjected to the control.

For example, in the example illustrated in FIG. 9A, it is defined that if the rate of inputting to the buffer 32 is higher than 50% and equal to or lower than 80%, the inclination of the input rate is negative, and the amount used by the buffer 32 is 0, the buffer monitoring section 31 executes the process of the operation instruction 1-5. Specifically, burst sizes of all flows are restored to the initial value. This is due to the fact that since the rate of inputting to the buffer 32 tends to decrease regardless of the high rate of inputting to the buffer 32 and the buffer 32 is empty, the buffer overflow is unlikely to occur even if a burst occurs in any flow.

For example, in the example illustrated in FIG. 9A, it is defined that if the rate of inputting to the buffer 32 is higher than 50% and equal to or lower than 80%, the inclination of the input rate is 0, and the amount used by the buffer 32 is larger than 0 and smaller than the burst size restoration threshold, the buffer monitoring section 31 executes the process of the operation instruction 1-3. Specifically, the burst size of a flow with a burst size of “0” is changed to half of the initial value. This is due to the fact that since the buffer 32 has a sufficient available region regardless of the fact that the rate of inputting to the buffer 32 tends to be maintained at a relatively high level, a flow that has a burst size of “0” and from which all frames have been discarded by a policer is transferred.

For example, in the example illustrated in FIG. 9A, it is defined that if the rate of inputting to the buffer 32 is higher than 50% and equal to or lower than 80%, the inclination of the input rate is negative, and the amount used by the buffer 32 is 0, the buffer monitoring section 31 executes the process of the operation instruction 1-4. Specifically, the burst size of a flow other than a flow to be subjected to the control is restored to the initial value. This is due to the fact that since the buffer 32 is empty and the rate of inputting to the buffer 32 tends to decrease regardless of the high rate of inputting to the buffer 32, the amount used by the buffer 32 is likely to decrease. In this case, the reason why the burst size of a flow to be subjected to the control is not restored to the initial value is that, for example, a burst may occur.

For example, in the example illustrated in FIG. 9A, it is defined that if the rate of inputting to the buffer 32 is higher than 50% and equal to or lower than 80%, and the inclination of the input rate is positive, the buffer monitoring section 31 executes the process of the operation instruction 2. Specifically, the burst size of a flow to be subjected to the control is changed to half of the initial value. This is due to the fact that since the rate of inputting to the buffer 32 is relatively high and tends to increase, the amount used by the buffer 32 is likely to increase. In this case, the reason why the burst size of a flow to be subjected to the control is changed to half of the initial value is that, for example, a burst may occur in the flow to be subjected to the control. In addition, in this case, the reason why the burst size of a flow other than the flow to be subjected to the control is not changed is that, for example, a burst is unlikely to occur in the flow other than the flow to be subjected to the control.

For example, in the example illustrated in FIG. 9B, it is defined that if the rate of inputting to the buffer 32 is higher than 80% and equal to or lower than 100%, the inclination of the input rate is negative, and the amount used by the buffer 32 is equal to or larger than the burst size restoration threshold, the buffer monitoring section 31 executes the process of the operation instruction 1-1. Specifically, the burst size of any flow is not changed. This is due to the fact that, regardless of a decreasing trend in the rate of inputting to the buffer 32, the amount used by the buffer 32 is large and the buffer overflow is likely to occur.

For example, in the example illustrated in FIG. 9B, it is defined that if the rate of inputting to the buffer 32 is higher than 80% and equal to or lower than 100%, the inclination of the input rate is negative, and the amount used by the buffer 32 is larger than 0 and smaller than the burst size restoration threshold, the buffer monitoring section 31 executes the process of the operation instruction 1-3. Specifically, the burst size of a flow with a burst size of “0” is changed to half of the initial value. This is due to the fact that since the rate of inputting to the buffer 32 tends to decrease regardless of the high rate of inputting to the buffer 32 and the buffer 32 is empty, the buffer 32 has a region sufficient to receive a burst. Thus, a flow that has a burst size of “0” and from which all frames have been discarded by a policer 20 is transferred.

For example, in the example illustrated in FIG. 9B, it is defined that if the rate of inputting to the buffer 32 is higher than 80% and equal to or lower than 100%, the inclination of the input rate is negative, and the amount used by the buffer 32 is 0, the buffer monitoring section 31 executes the process of the operation instruction 1-4. Specifically, the burst size of a flow other than a flow to be subjected to the control is restored to the initial value. This is due to the fact that since the buffer 32 is empty and the rate of inputting to the buffer 32 tends to decrease regardless of the high rate of inputting to the buffer 32, the amount used by the buffer 32 is likely to decrease.

For example, in the example illustrated in FIG. 9B, it is defined that if the rate of inputting to the buffer 32 is higher than 80% and equal to or lower than 100% and the inclination of the input rate is 0, the buffer monitoring section 31 executes the process of the operation instruction 2. Specifically, the burst size of a flow to be subjected to the control is changed to half of the initial value. This is due to the fact that since the rate of inputting to the buffer 32 tends to be maintained at a high level, the amount used by the buffer 32 is likely to increase and the buffer overflow is likely to occur.

For example, in the example illustrated in FIG. 9B, it is defined that if the rate of inputting to the buffer 32 is higher than 80% and equal to or lower than 100% and the inclination of the input rate is positive, the buffer monitoring section 31 executes the process of the operation instruction 3. Specifically, burst sizes of all flows that will be input to the buffer 32 are changed to half of the initial value. This is due to the fact that since the rate of inputting to the buffer 32 is high and tends to increase, the buffer overflow is likely to occur in the buffer 32.

For example, in the example illustrated in FIG. 9B, it is defined that if the rate of inputting to the buffer 32 is higher than 100% and the inclination of the input rate is negative, the buffer monitoring section 31 executes the process of the operation instruction 3. Specifically, burst sizes of all flows that will be input to the buffer 32 are changed to half of the initial value. This is due to the fact that, regardless of a decreasing trend in the rate of inputting to the buffer 32, the rate of inputting to the buffer 32 is higher than the reading bandwidth, and the accumulation of frames in the buffer 32 already starts and continues until the rate of inputting to the buffer 32 becomes lower than the reading bandwidth.

For example, in the example illustrated in FIG. 9B, it is defined that if the rate of inputting to the buffer 32 is higher than 100% and the inclination of the input rate is 0, the buffer monitoring section 31 executes the process of the operation instruction 4. Specifically, the burst size of a flow to be subjected to the control is changed to “0” and the burst size of a flow other than the flow to be subjected to the control is changed to half of the initial value. This is due to the fact that the rate of inputting to the buffer 32 is higher than the reading bandwidth, the accumulation of frames in the buffer 32 already starts, the rate of inputting to the buffer 32 tends to be maintained, the rate of accumulating frames in the buffer 32 is maintained, and the buffer overflow is likely to occur.

For example, in the example illustrated in FIG. 9B, it is defined that if the rate of inputting to the buffer 32 is higher than 100% and the inclination of the input rate is positive, the buffer monitoring section 31 executes the process of the operation instruction 5. Specifically, burst sizes of all flows that will be input to the buffer 32 are changed to “0”. This is due to the fact that the rate of inputting to the buffer 32 is higher than the reading bandwidth, the accumulation of frames in the buffer 32 already starts, the rate of inputting to the buffer 32 tends to increase, the rate of accumulating the frames in the buffer 32 increases, and the buffer overflow is likely to occur. By changing the burst sizes of all the flows to “0”, the flow of a frame into the buffer 32 is stopped. Then, the amount used by the buffer 32 is reduced by reading a frame from the buffer 32 at the reading bandwidth.

According to the process details, illustrated in FIGS. 9A and 9B, of the buffer monitoring section 31, a process of reducing a burst size is executed in a stepwise manner based on either or both of the rate of inputting to the buffer 32 and the inclination of the rate of inputting to the buffer 32. The burst size control by the buffer monitoring section 31 is not limited to the example illustrated in FIGS. 9A and 9B. In the case where a burst size is reduced, the burst size after a change in the burst size is not limited to half of the initial value.

The control to be executed to reduce a burst size by the buffer monitoring section 31 is not limited to the control to be executed based on the rate of inputting to the buffer 32 and the inclination of the rate of inputting to the buffer 32. The control to be executed to reduce a burst size may be executed by the buffer monitoring section 31 based on either one of the rate of inputting to the buffer 32 and the inclination of the rate of inputting to the buffer 32.

The control to be executed to increase a burst size by the buffer monitoring section 31 is not limited to the control to be executed based on the rate of inputting to the buffer 32, the inclination of the rate of inputting to the buffer 32, and the amount used by the buffer 32. The control to be executed to increase a burst size may be executed by the buffer monitoring section 31 based on one or two of the rate of inputting to the buffer 32, the inclination of the rate of inputting to the buffer 32, and the amount used by the buffer 32.

The rate of 50% of the reading bandwidth in the example illustrated in FIG. 9A is an example of a “first threshold”. The “first threshold”, however, is not limited to the rate of 50% of the reading bandwidth and may be the rate of 80% of the reading bandwidth or the rate of 100% of the reading bandwidth. The rate of 80% of the reading bandwidth in the example illustrated in FIGS. 9A and 9B is an example of a “second threshold”. The “second threshold”, however, is not limited to the rate of 80% of the reading bandwidth.

Flow of Process

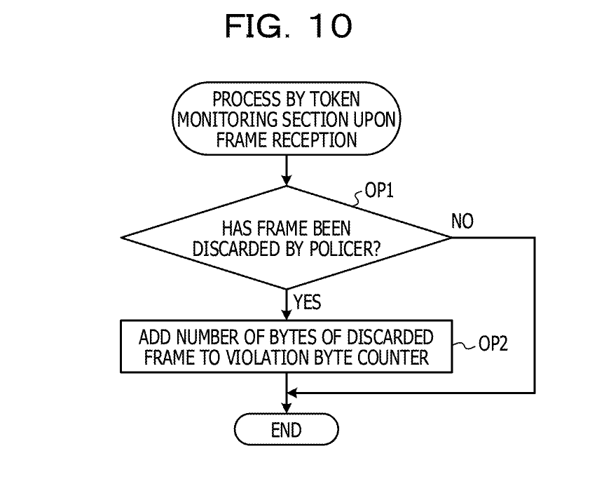

FIG. 10 is an example of a flowchart of a process to be executed by a token monitoring section 23 upon the reception of a frame. A process illustrated in FIG. 10 is started when a frame arrives at a policer 20 including the token monitoring section 23.

In OP1, the token monitoring section 23 determines whether or not the frame has been discarded by the policer 20. For example, the determination of OP1 is made based on the result of determining whether or not a token bucket for the policer 20 is empty. For example, if the token bucket for the policer 20 is empty, the frame has been discarded by the policer 20.

If the frame has been discarded by the policer 20 (YES in OP1), the process proceeds to OP2. If the frame has not been discarded by the policer 20 (NO in OP1), the process illustrated in FIG. 10 is terminated.

In OP2, the token monitoring section 23 adds the number of bytes of the discarded frame to a violation byte counter. The violation byte counter is a counter for counting a data amount of a frame discarded by the policer 20. After OP2, the process illustrated in FIG. 10 is terminated.

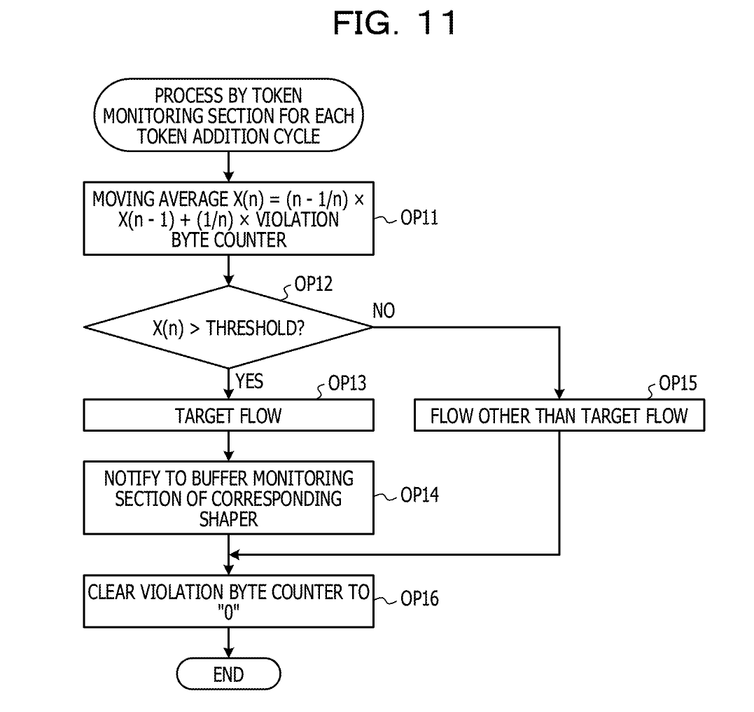

FIG. 11 is an example of a flowchart of a process, to be executed by a token monitoring section 23, of determining a flow to be subjected to the control. The example illustrated in FIG. 11 indicates a flowchart of a process to be executed in the case where the token monitoring section 23 uses the aforementioned second method to determine a flow to be subjected to the control. The second method for determining a flow to be subjected to the control uses a moving average of a discarded data amount. In the example illustrated in FIG. 11, the process is executed for each of token addition cycles of a token bucket for a policer 20 including the token monitoring section 23.

In OP11, the token monitoring section 23 calculates a moving average of a discarded data amount. The moving average of the discarded data amount is calculated according to the following Equation 3, for example.

$$X ( n ) = \frac{n - 1}{n} \times X ( n - 1 ) + \frac{1}{n} \times the violation byte counter \qquad ( Equation 3 )$$

In Equation 3, n is a variable defining a time period for the calculation of the moving average (the time period for the calculation of the moving average=a token addition cycle×n), X(n) is the moving average of the discarded data amount, and M(n−1) is a moving average of a discarded data amount in a previous single token addition cycle.

In OP12, the token monitoring section 23 determines whether or not the moving average, calculated in OP11, of the discarded data amount is larger than the threshold. If the moving average of the discarded data amount is larger than the threshold (YES in OP12), the process proceeds to OP13. If the moving average of the discarded data amount is equal to or smaller than the threshold (NO in OP12), the process proceeds to OP14.

In OP13, the token monitoring section 23 determines that a target flow of the policer 20 is to be subjected to the burst size control. In OP14, the token monitoring section 23 notifies information of the target flow of the policer 20 to a buffer monitoring section 31 of a corresponding shaper 30. The information notified to the buffer monitoring section 31 is, for example, identification information of the policer 20. The destination shaper 30 is determined by a controller (not illustrated) of the switch 1 based on a destination address of the target flow of the policer 20.

In OP15, the token monitoring section 23 determines that the target flow of the policer 20 is not to be subjected to the burst size control. In OP16, the token monitoring section 23 clears the value of the violation byte counter to 0. After that, the process illustrated in FIG. 11 is terminated.

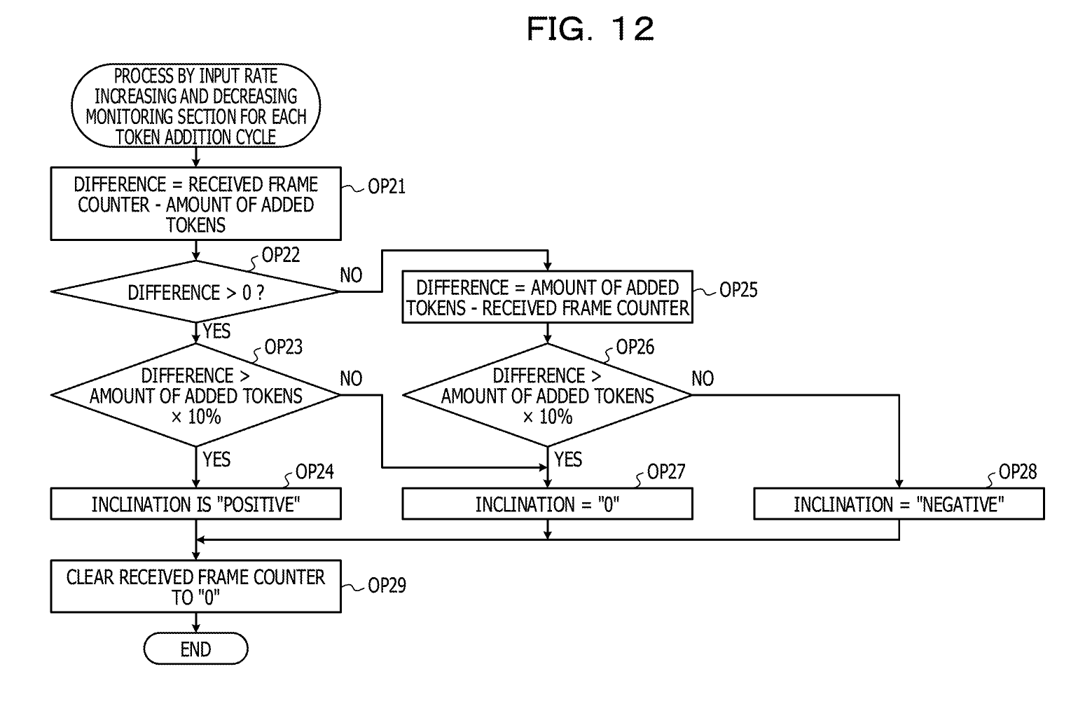

FIG. 12 is an example of a process to be executed by the input rate increase and decrease monitoring section 36. The process illustrated in FIG. 12 is executed for each of token addition cycles of the token bucket included in the input rate monitoring section 35 and used for the detection of the rate of 100%, for example.

In OP21, the input rate increase and decrease monitoring section 36 calculates a difference by subtracting the amount of added tokens from a value of a received frame counter. For example, since a single frame is output for a single token, the received frame counter counts the number of frames input to the buffer 32.

In OP22, the input rate increase and decrease monitoring section 36 determines whether or not the difference calculated by subtracting the amount of the added tokens from the value of the received frame counter is a positive value. If the difference calculated by subtracting the amount of the added tokens from the value of the received frame counter is the positive value (YES in OP22), the process proceeds to OP23. If the difference calculated by subtracting the amount of the added tokens from the value of the received frame counter is not the positive value (NO in OP22), the process proceeds to OP25.

Processes of OP23 and OP24 are executed if the difference calculated by subtracting the amount of the added tokens from the value of the received frame counter is the positive value. In OP23, the input rate increase and decrease monitoring section 36 determines whether or not the difference calculated by subtracting the amount of the added tokens from the value of the received frame counter is larger than 10% of the amount of the added tokens.

If the difference calculated by subtracting the amount of the added tokens from the value of the received frame counter is larger than 10% of the amount of the added tokens (YES in OP23), the process proceeds to OP24. In OP24, the input rate increase and decrease monitoring section 36 determines that the inclination of the rate of inputting to the buffer 32 is “positive”.

If the difference calculated by subtracting the amount of the added tokens from the value of the received frame counter is equal to or smaller than 10% of the amount of the added tokens (NO in OP23), the process proceeds to OP27. In OP27, the input rate increase and decrease monitoring section 36 determines that the inclination of the rate of inputting to the buffer 32 is “0”.

Processes of OP25 and OP26 are executed if the difference calculated by subtracting the amount of the added tokens from the value of the received frame counter is not the positive value. In OP25, the input rate increase and decrease monitoring section 36 calculates a difference by subtracting the value of the received frame counter from the amount of the added tokens.

In OP26, the input rate increase and decrease monitoring section 36 determines whether or not the difference calculated by subtracting the value of the received frame counter from the amount of the added tokens is larger than 10% of the amount of the added tokens. If the difference calculated by subtracting the value of the received frame counter from the amount of the added tokens is larger than 10% of the amount of the added tokens (YES in OP26), the process proceeds to OP27. In OP27, the input rate increase and decrease monitoring section 36 determines that the inclination of the rate of inputting to the buffer 32 is “0”.

If the difference calculated by subtracting the value of the received frame counter from the amount of the added tokens is equal to or smaller than 10% of the amount of the added tokens (NO in OP26), the process proceeds to OP28. In OP28, the input rate increase and decrease monitoring section 36 determines that the inclination of the rate of inputting to the buffer 32 is “negative”.

In OP29, the input rate increase and decrease monitoring section 36 clears the value of the received frame counter to 0. After that, the process illustrated in FIG. 12 is terminated.

In the example illustrated in FIG. 12, if the difference between the value of the received frame counter and the amount of the added tokens is small, the inclination of the rate of inputting to the buffer 32 is treated as 0 or the rate of inputting to the buffer 32 is treated to be equal to or nearly equal to the reading bandwidth of the buffer 32. This is due to the fact that if the difference between the value of the received frame counter and the amount of the added tokens is small, a variation in the amount used by the buffer 32 is small and the frequent execution of the burst size control of the policer 20 is suppressed. The threshold for the difference between the value of the received frame counter and the amount of the added tokens is used to treat the inclination of the rate of inputting to the buffer 32 as 0 and is not limited to 10% of the amount of the added tokens.

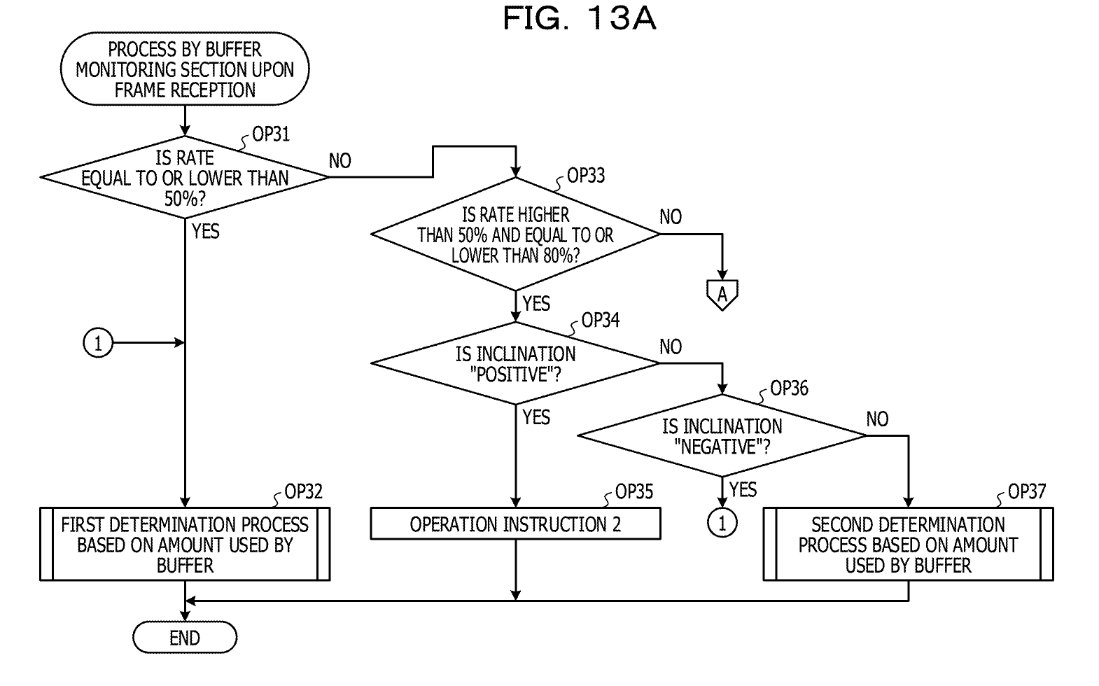

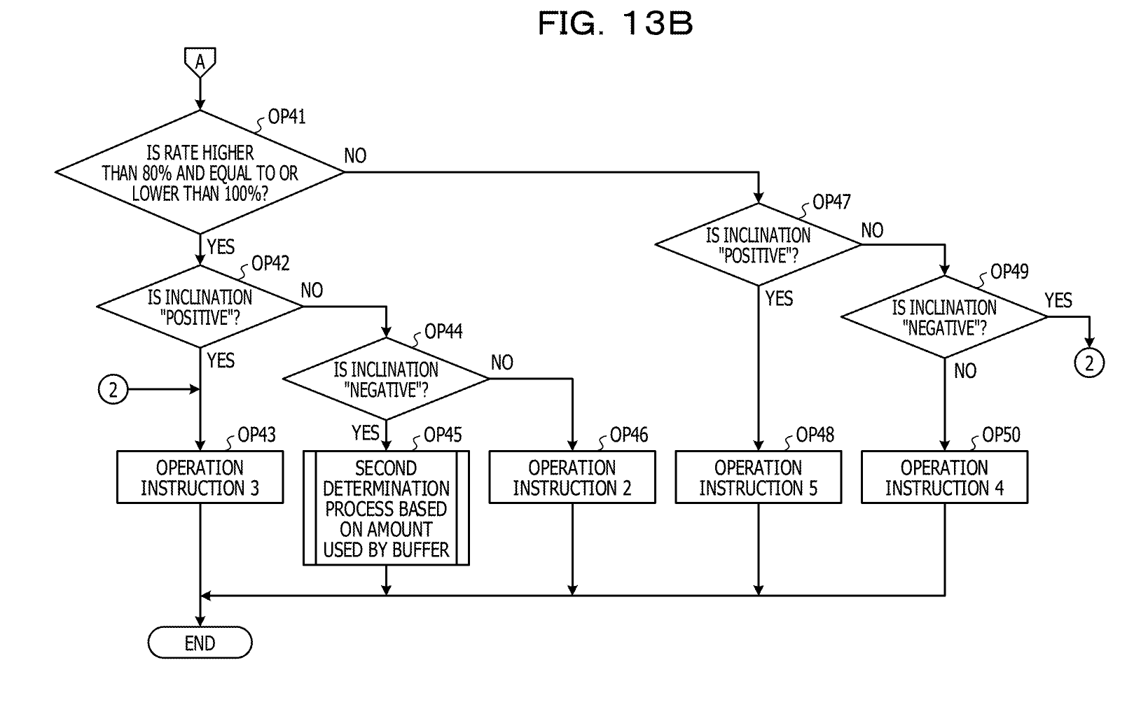

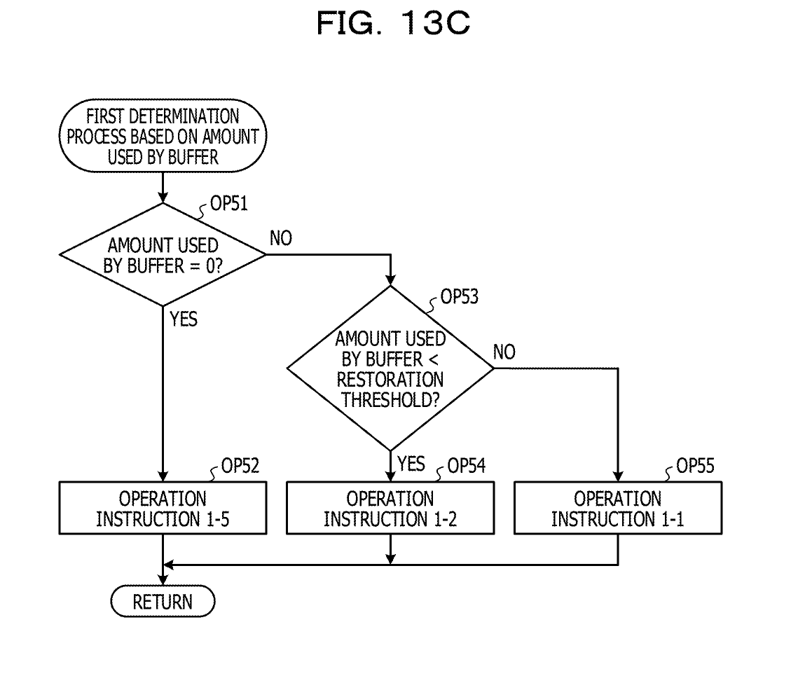

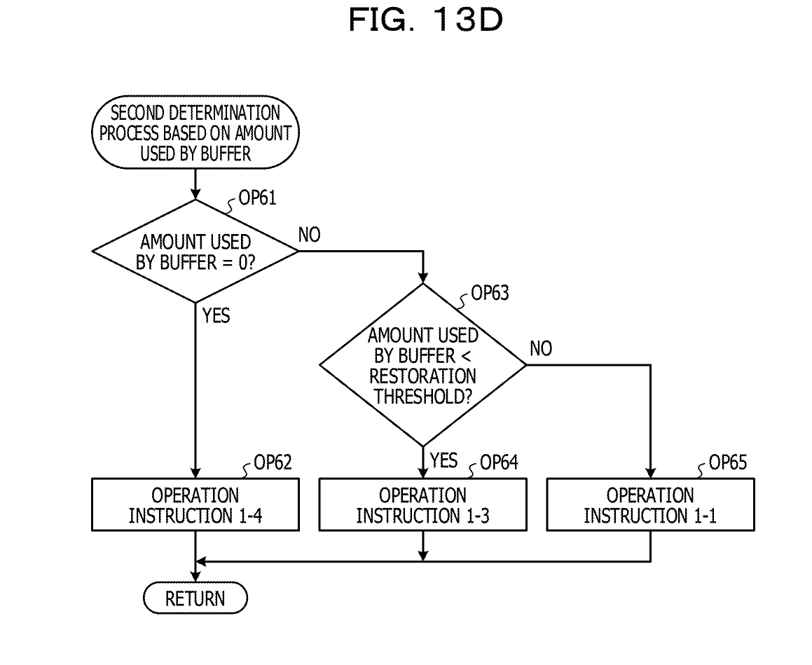

FIGS. 13A, 13B, 13C, and 13D are examples of flowcharts of processes to be executed by the buffer monitoring section 31. The processes illustrated in FIGS. 13A to 13D are executed in the case where the processes to be executed by the buffer monitoring section 31 are defined by the process details illustrated in FIGS. 9A and 9B. The process illustrated in FIG. 13A is started when a frame arrives at the buffer 32, for example.

In OP31, the buffer monitoring section 31 determines whether or not the result of monitoring the rate of inputting to the buffer 32 is equal to or lower than the rate of 50% of the reading bandwidth of the buffer 32. If the result of monitoring the rate of inputting to the buffer 32 is equal to or lower than the rate of 50% of the reading bandwidth of the buffer 32 (YES in OP31), the process proceeds to OP32. If the result of monitoring the rate of inputting to the buffer 32 is higher than the rate of 50% of the reading bandwidth of the buffer 32 (NO in OP31), the process proceeds to OP33.

In OP32, a first determination process based on the amount used by the buffer 32 is executed. The first determination process based on the amount used by the buffer 32 is described later in detail. When the first determination process based on the amount used by the buffer 32 is terminated, the process illustrated in FIG. 13A is terminated.

In OP33, the buffer monitoring section 31 determines whether or not the result of monitoring the rate of inputting to the buffer 32 is higher than the rate of 50% of the reading bandwidth of the buffer 32 and equal to or lower than the rate of 80% of the reading bandwidth of the buffer 32. If the result of monitoring the rate of inputting to the buffer 32 is higher than the rate of 50% of the reading bandwidth of the buffer 32 and equal to or lower than the rate of 80% of the reading bandwidth of the buffer 32 (YES in OP33), the process proceeds to OP34. If the result of monitoring the rate of inputting to the buffer 32 is higher than the rate of 80% of the reading bandwidth of the buffer 32 (NO in OP33), the process proceeds to OP41 illustrated in FIG. 13B.

In OP34, the buffer monitoring section 31 determines whether or not the result of monitoring the inclination of the rate of inputting to the buffer 32 is “positive”. If the result of monitoring the inclination of the rate of inputting to the buffer 32 is “positive” (YES in OP34), the process proceeds to OP35. If the result of monitoring the inclination of the rate of inputting to the buffer 32 is not “positive” (NO in OP34), the process proceeds to OP36.

In OP35, the buffer monitoring section 31 executes the process of the operation instruction 2. Specifically, since the rate of inputting to the buffer 32 is higher than the rate of 50% of the reading bandwidth and tends to further increase, the buffer monitoring section 31 transmits, to a burst size setting section 21 of a policer 20 corresponding to a flow to be subjected to the control, a burst size change instruction to change a burst size to half of the initial value. After that, the process illustrated in FIG. 13A is terminated.

In OP36, the buffer monitoring section 31 determines whether or not the result of monitoring the inclination of the rate of inputting to the buffer 32 is “negative”. If the result of monitoring the inclination of the rate of inputting to the buffer 32 is “negative” (YES in OP36), the process proceeds to OP32. If the result of monitoring the inclination of the rate of inputting to the buffer 32 is “0” (NO in OP36), the process proceeds to OP37.

In OP37, a second determination process based on the amount used by the buffer 32 is executed. The second determination process based on the amount used by the buffer 32 is described later in detail. When the second determination process based on the amount used by the buffer 32 is terminated, the process illustrated in FIG. 13A is terminated.

In OP41 illustrated in FIG. 13B, the buffer monitoring section 31 determines whether or not the result of monitoring the rate of inputting to the buffer 32 is higher than the rate of 80% of the reading bandwidth of the buffer 32 and equal to or lower than the rate of 100% of the reading bandwidth of the buffer 32. If the result of monitoring the rate of inputting to the buffer 32 is higher than the rate of 80% of the reading bandwidth of the buffer 32 and equal to or lower than the rate of 100% of the reading bandwidth of the buffer 32 (YES in OP41), the process proceeds to OP42. If the result of monitoring the rate of inputting to the buffer 32 is higher than the rate of 100% of the reading bandwidth of the buffer 32 (NO in OP41), the process proceeds to OP47.

In OP42, the buffer monitoring section 31 determines whether or not the result of monitoring the inclination of the rate of inputting to the buffer 32 is “positive”. If the result of monitoring the inclination of the rate of inputting to the buffer 32 is “positive” (YES in OP42), the process proceeds to OP43. If the result of monitoring the inclination of the rate of inputting to the buffer 32 is not “positive” (NO in OP42), the process proceeds to OP44.

In OP43, the buffer monitoring section 31 executes the process of the operation instruction 3. Specifically, since the rate of inputting to the buffer 32 is higher than the rate of 80% of the reading bandwidth and tends to further increase, the buffer monitoring section 31 transmits, to burst size setting sections 21 of policers 20 corresponding to all flows that will be input to the buffer 32, a burst size change instruction to change burst sizes to half of the initial value. After that, the process illustrated in FIG. 13B is terminated.

In OP44, the buffer monitoring section 31 determines whether or not the result of monitoring the inclination of the rate of inputting to the buffer 32 is “negative”. If the result of monitoring the inclination of the rate of inputting to the buffer 32 is “negative” (YES in OP44), the process proceeds to OP45. If the result of monitoring the inclination of the rate of inputting to the buffer 32 is “0” (NO in OP44), the process proceeds to OP46.

In OP45, the second determination process based on the amount used by the buffer 32 is executed. When the second determination process based on the amount used by the buffer 32 is terminated, the process illustrated in FIG. 13B is terminated.

In OP46, the buffer monitoring section 31 executes the process of the operation instruction 2. Specifically, the rate of inputting to the buffer 32 is higher than the rate of 80% of the reading bandwidth and tends to be maintained. Thus, the buffer monitoring section 31 transmits, to the burst size setting section 21 of the policer 20 corresponding to the flow to be subjected to the control, a burst size change instruction to change the burst size of the flow to half of the initial value. After that, the process illustrated in FIG. 13B is terminated.

In OP47, the buffer monitoring section 31 determines whether or not the result of monitoring the inclination of the rate of inputting to the buffer 32 is “positive”. If the result of monitoring the inclination of the rate of inputting to the buffer 32 is “positive” (YES in OP47), the process proceeds to OP48. If the result of monitoring the inclination of the rate of inputting to the buffer 32 is not “positive” (NO in OP47), the process proceeds to OP49.

In OP48, the buffer monitoring section 31 executes the process of the operational instruction 5. Specifically, the rate of inputting to the buffer 32 is higher than the rate of 100% of the reading bandwidth and tends to further increase. Thus, the buffer monitoring section 31 transmits, to the burst size setting sections 21 of the policers 20 corresponding to all the flows that will be input to the buffer 32, a burst size change instruction to change the burst sizes to 0. After that, the process illustrated in FIG. 13B is terminated.

In OP49, the buffer monitoring section 31 determines whether or not the result of monitoring the inclination of the rate of inputting to the buffer 32 is “negative”. If the result of monitoring the inclination of the rate of inputting to the buffer 32 is “negative” (YES in OP49), the process proceeds to OP43. If the result of monitoring the inclination of the rate of inputting to the buffer 32 is “0” (NO in OP49), the process proceeds to OP50.

In OP50, the buffer monitoring section 31 executes the process of the operation instruction 4. Specifically, the current rate of inputting to the buffer 32 is higher than the rate of 100% of the reading bandwidth and tends to be maintained. Thus, the buffer monitoring section 31 transmits, to the burst size setting section 21 of the policer 20 corresponding to the flow to be subjected to the control, a burst size change instruction to change the burst size to 0. The buffer monitoring section 31 transmits, to a burst size setting section 21 of a policer 20 corresponding to a flow other than the flow to be subjected to the control, a burst size change instruction to change a burst size to half of the initial value. After that, the process illustrated in FIG. 13B is terminated.

FIG. 13C is an example of a flowchart of the first determination process based on the amount used by the buffer 32. The process illustrated in FIG. 13C is executed in OP32 illustrated in FIG. 13A.

In OP51, the buffer monitoring section 31 determines whether or not the amount used by the buffer 32 is 0. If the amount used by the buffer 32 is 0 (YES in OP51), the process proceeds to OP52. If the amount used by the buffer 32 is not 0 (NO in OP51), the process proceeds to OP53.

In OP52, the buffer monitoring section 31 executes the process of the operation instruction 1-5. Specifically, the rate of inputting to the buffer 32 is equal to or lower than the rate of 50% of the reading bandwidth and the amount used by the buffer 32 is 0. Thus, the buffer monitoring section 31 transmits, to the burst size setting sections 21 of the policers 20 corresponding to all the flows that will be input to the buffer 32, a burst size change instruction to change the burst sizes to the initial value. After that, the process illustrated in FIG. 13C is terminated and the process illustrated in FIG. 13A is terminated.

In OP53, the buffer monitoring section 31 determines whether or not the amount used by the buffer 32 is larger than 0 and smaller than the burst size restoration threshold. If the amount used by the buffer 32 is larger than 0 and smaller than the burst size restoration threshold (YES in OP53), the process proceeds to OP54. If the amount used by the buffer 32 is equal to or larger than the burst size restoration threshold (NO in OP53), the process proceeds to OP55.

In OP54, the buffer monitoring section 31 executes the process of the operation instruction 1-2. Specifically, the rate of inputting to the buffer 32 is equal to or lower than the rate of 50% of the reading bandwidth and the amount used by the buffer 32 has decreased to a value lower than the burst size restoration threshold. In this case, the buffer monitoring section 31 transmits, to a burst size setting section 21 of a policer 20 corresponding to a flow with a burst size of 0, a burst size change instruction to change the burst size to half of the initial value. The buffer monitoring section 31 transmits, to a burst size setting section 21 of a policer 20 corresponding to a flow with a burst size of half of the initial value, a burst size change instruction to change the burst size to the initial value. After that, the process illustrated in FIG. 13C is terminated and the process illustrated in FIG. 13A is terminated.

In OP55, the buffer monitoring section 31 executes the process of the operation instruction 1-1. Specifically, since the rate of inputting to the buffer 32 is equal to or lower than the rate of 50% of the reading bandwidth and the amount used by the buffer 32 is equal to or larger than the burst size restoration threshold, the buffer monitoring section 31 does not change the burst size of any flow. After that, the process illustrated in FIG. 13C is terminated and the process illustrated in FIG. 13A is terminated.

FIG. 13D is an example of a flowchart of the second determination process based on the amount used by the buffer 32. The process illustrated in FIG. 13D is executed in OP37 illustrated in FIG. 13A and OP45 illustrated in FIG. 13B.

In OP61, the buffer monitoring section 31 determines whether or not the amount used by the buffer 32 is 0. If the amount used by the buffer 32 is 0 (YES in OP61), the process proceeds to OP62. If the amount used by the buffer 32 is not 0 (NO in OP61), the process proceeds to OP63.

In OP62, the buffer monitoring section 31 executes the process of the operation instruction 1-4. Specifically, the buffer monitoring section 31 transmits, to the burst size setting section 21 of the policer 20 corresponding to the flow other than the flow to be subjected to the control, a burst size change instruction to change the burst size to the initial value. After that, the process illustrated in FIG. 13D is terminated and the process illustrated in FIG. 13A or 13B is terminated.

In OP63, the buffer monitoring section 31 determines whether or not the amount used by the buffer 32 is larger than 0 and smaller than the burst size restoration threshold. If the amount used by the buffer 32 is larger than 0 and smaller than the burst size restoration threshold (YES in OP63), the process proceeds to OP64. If the amount used by the buffer 32 is equal to or larger than the burst size restoration threshold (NO in OP63), the process proceeds to OP65.

In OP64, the buffer monitoring section 31 executes the process of operation instruction 1-3. Specifically, the buffer monitoring section 31 transmits, to the burst size setting section 21 of the policer 20 corresponding to the flow with the burst size of 0, a burst size change instruction to change the burst size to half of the initial value. After that, the process illustrated in FIG. 13D is terminated and the process illustrated in FIG. 13A or 13B is terminated.

In OP65, the buffer monitoring section 31 executes the process of operation instruction 1-1. Specifically, since the amount used by the buffer 32 is equal to or larger than the burst size restoration threshold, the buffer monitoring section 31 does not change the burst size of any flow. After that, the process illustrated in FIG. 13D is terminated and the process illustrated in FIG. 13A or 13B is terminated.

The processes of the flowcharts illustrated in FIGS. 10 to 13D are examples. The processes to be executed by the token monitoring section 23, the input rate increase and decrease monitoring section 36, and the buffer monitoring section 31 are not limited to the processes illustrated in FIGS. 10 to 13D.

### Effects of First Embodiment

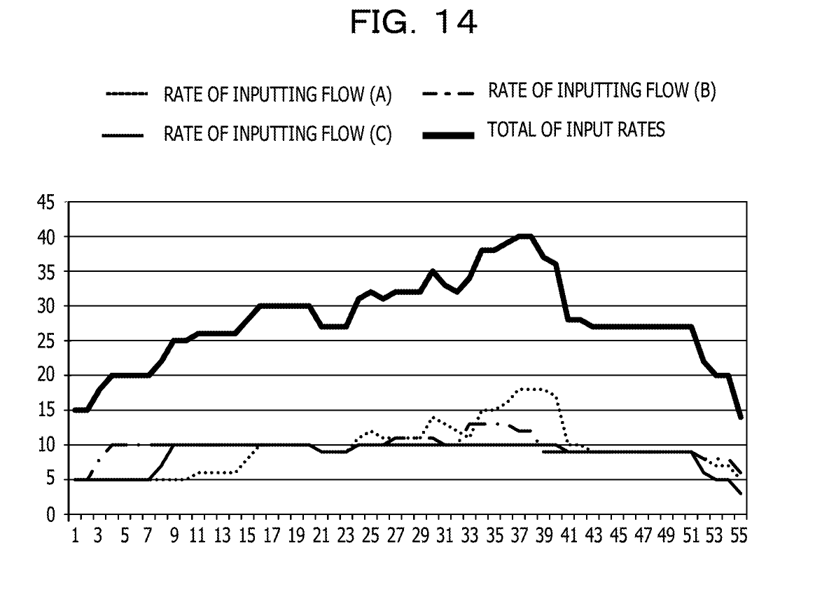

FIG. 14 is an example of a graph indicating the rates of inputting flows A, B, and C and the total of the rates in a specific example. The specific example assumes that frames of the three flows A, B, and C are input to the buffer 32. The specific example assumes that the reading bandwidth of the buffer 32 is 30 Mbps.

FIG. 14 illustrates the example in which the frames of the flows A, B, and C are input to the buffer 32, while a burst occurs or the total of the rates of inputting the flows A, B, and C increases from 15 Mbps to a value equal to or larger than 30 Mbps.

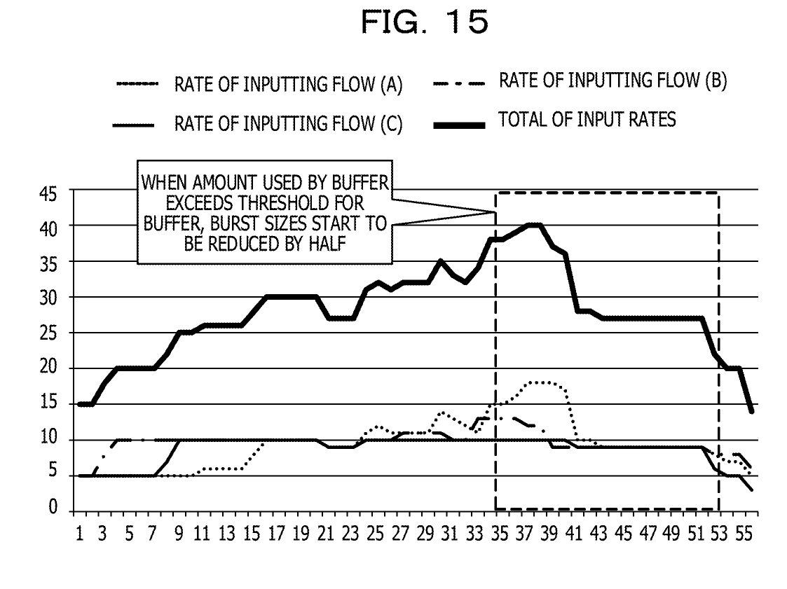

FIG. 15 is an example of a graph indicating the rates of inputting the flows A, B, and C and the total of the input rates in the case where the buffer 32 is controlled using the first method. FIG. 15 illustrates the rates of inputting the flows A, B, and C to the buffer 32 in the case where traffic of the flows A, B, and C illustrated in FIG. 14 is input to the switch 1.

In the example illustrated in FIG. 15, as burst size control based on the first method, control is executed to reduce burst sizes of all flows that will be input to the buffer 32 to half of the initial value if the amount used by the buffer 32 reaches the threshold.

In the example illustrated in FIG. 15, a portion surrounded by a rectangle indicated by a dotted line indicates a time period during which the amount used by the buffer 32 exceeds the threshold. When the amount used by the buffer 32 exceeds the threshold and burst sizes of the flows A, B, and C are reduced by half, tokens of policers for the flows are already consumed and amounts of accumulated tokens of the policers for the flows are likely to be values equal to or smaller than half of the initial value.

If the amounts of accumulated tokens of the policers for the flows are equal to or smaller than half of the initial value, and the burst sizes are reduced by half, the amounts of accumulated tokens of the policers for the flows do not change, and traffic of the flows is input to the buffer 32.

Thus, the graph illustrated in FIG. 15 and indicating the rates of inputting the flows A, B, and C and the total of the input rates in the case where the burst size control based on the first method is executed is the same as the graph illustrated in FIG. 14.

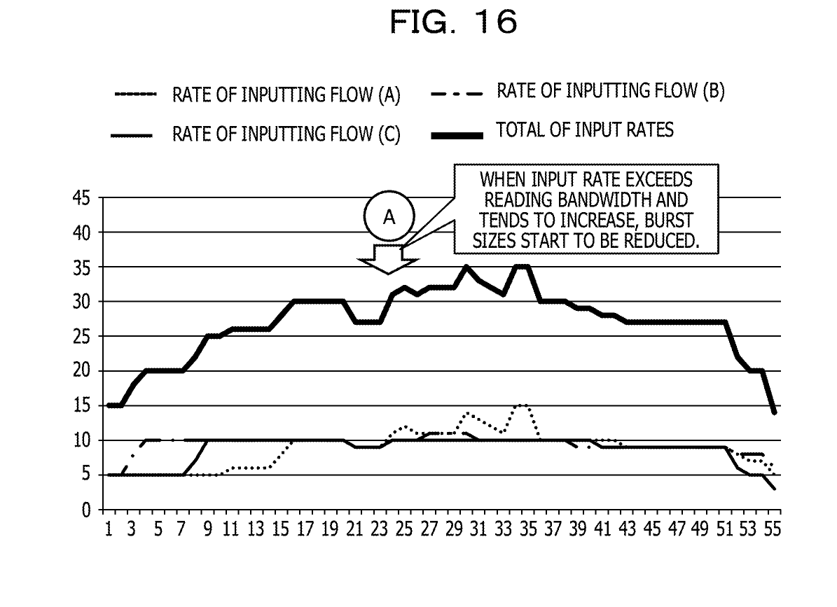

FIG. 16 is an example of a graph indicating the rates of inputting the flows A, B, and C and the total of the input rates in the case where the burst size control according to the embodiment is executed on the buffer 32. FIG. 16 illustrates the rates of inputting the flows to the buffer 32 in the case where the traffic of the flows A, B, and C illustrated in FIG. 14 is input to the switch 1.

In the example illustrated in FIG. 16, control is executed to reduce burst sizes of all flows that will be input to the buffer 32 to half of the initial value if the rate of inputting to the buffer 32 exceeds the rate of 10% of the reading bandwidth of the buffer 32 and the inclination of the rate of inputting to the buffer 32 is “0”. In the example illustrated in FIG. 16, a threshold to be used to determine that the inclination of the rate of inputting to the buffer 32 is “0” is 3% of the reading bandwidth of the buffer 32 (refer to OP23 and OP26 illustrated in FIG. 12).

In the example illustrated in FIG. 16, the burst sizes of the flows A, B, and C are reduced by half at time A when the total of the rates of inputting the flows A, B, and C exceeds the reading bandwidth (of 30 Mbps) and when it is detected that the input rate tends to increase. At the time A, amounts of accumulated tokens for the flows are likely to be equal to or larger than halves of the burst sizes and are reduced by reducing the burst sizes by half. After the time A, the maximum values of the rates of inputting the flows to the buffer 32 are reduced.

It is, therefore, apparent that the graph illustrated in FIG. 16 is different from the graph illustrated in FIG. 15 in the following features. First, time when the burst sizes are reduced in the graph illustrated in FIG. 16 is earlier than that in the graph illustrated in FIG. 15. Next, a time period during which the total of the input rates exceeds the reading bandwidth of the buffer 32 in the graph illustrated in FIG. 16 is shorter than that in the graph illustrated in FIG. 15. Furthermore, the excess amount when the total of the rates of inputting all the flows exceeds the reading bandwidth of the buffer 32 in the graph illustrated in FIG. 16 is smaller than that in the graph illustrated in FIG. 15.

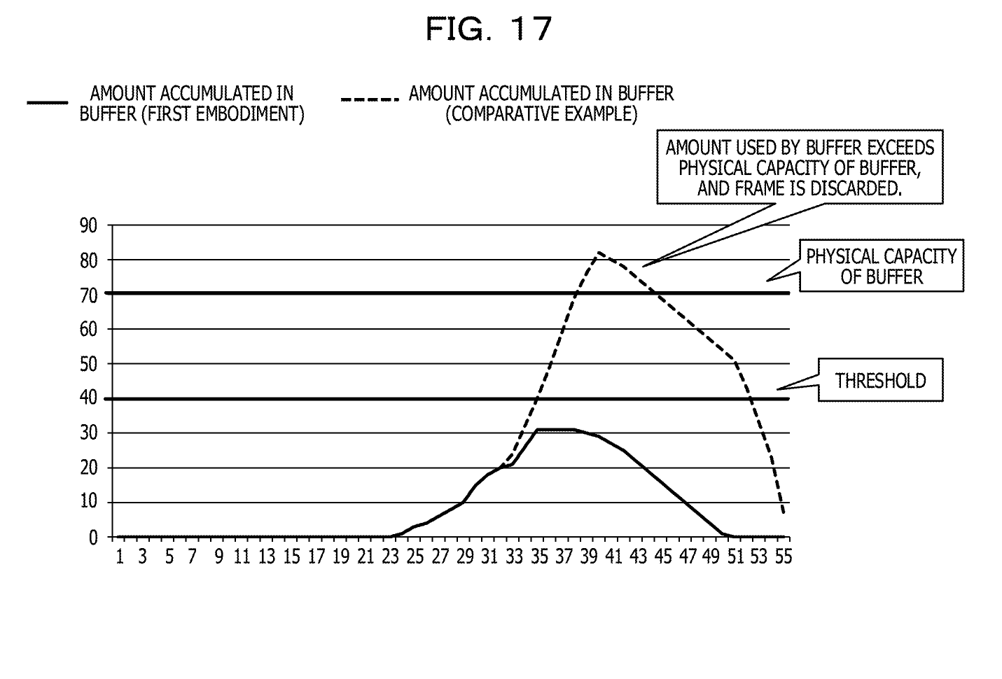

FIG. 17 is an example of a graph indicating the amount used by the buffer in the burst size control according to the embodiment and a graph indicating the amount used by the buffer in the burst size control using the first method. The graph illustrated in FIG. 17 and indicating the amount used by the buffer 32 in the case where the burst size control according to the embodiment is executed is obtained in the case where the rates of inputting the flows to the buffer 32 change as illustrated in FIG. 16. The graph illustrated in FIG. 17 and indicating the amount used by the buffer 32 in the case where the burst size control based on the first method is executed is obtained in the case where the rates of inputting the flows to the buffer 32 change as illustrated in FIG. 15.

In the burst size control based on the first method, the amount used by the buffer 32 exceeds a physical capacity of the buffer 32 and a frame is discarded in the buffer 32. On the other hand, in the burst size control according to the embodiment, the amount used by the buffer 32 does not exceed the physical capacity of the buffer 32 and a frame is not discarded in the buffer 32.

Thus, according to the embodiment, burst sizes may be reduced at earlier time by monitoring the rate of inputting to the buffer 32 and determining the timing of executing the burst size control based on the result of monitoring the input rate. Accordingly, if a burst occurs in a flow that will be input to the buffer 32, the amount of data to be input to the buffer 32 may be suppressed and the buffer overflow may be suppressed.

According to the embodiment, the start of the accumulation of frames in the buffer 32 may be estimated by executing the burst size control based on the rate of inputting to the buffer 32 and the reading bandwidth of the buffer 32. By estimating the start of the accumulation of frames in the buffer 32, a burst size may be reduced in a state in which the amount of frames accumulated in the buffer 32 is small, and the buffer overflow may be suppressed.

According to the embodiment, a frequent change in a burst size may be suppressed by determining the timing of executing the burst size control based on a combination of the rate of inputting to the buffer 32 and an increasing or decreasing trend in the rate of inputting to the buffer 32.

According to the embodiment, if the rate of inputting to the buffer 32 is higher than the threshold equal to or lower than the reading bandwidth of the buffer 32 and tends to increase, a burst size may be reduced by the burst size control before the start of the accumulation of frames in the buffer 32. According to the embodiment, since the multiple thresholds for the rate of inputting to the buffer 32 are used, flows with burst sizes to be reduced may be selected at stages.

According to the embodiment, the control is executed to increase a reduced burst size based on the rate of inputting to the buffer 32, an increasing or decreasing trend in the rate of inputting to the buffer 32, and the amount used by the buffer 32. Thus, when a burst is ended, burst sizes of flows may be restored to normal states.

According to the embodiment, flows to be subjected to the burst size control are selected in order from a flow of traffic that is likely to be burst traffic. Thus, the burst size control may suppress an effect given to a flow that is transmitted by a good user and unlikely to include burst traffic.

According to the embodiment, the rate of inputting to the buffer 32 is monitored using the token buckets for the multiple rates. Although multiple flows are input from the multiple policers 20 to the buffer 32, the flows to be input to the buffer 32 vary. It is, therefore, difficult to directly acquire the rate of inputting to the buffer 32 or calculate the total of the rates of inputting the flows output from the policers 20 to the buffer 32. The rate of inputting to the buffer 32 may be monitored by the simple configuration using the token buckets.

According to the embodiment, increasing and decreasing trends in the rate of inputting to the buffer 32 may be estimated based on the difference between the amount of data input to the buffer 32 in a cycle based on the reading bandwidth of the buffer 32 and the amount of data read from the buffer 32 in the cycle based on the reading bandwidth of the buffer 32. As described above, since it is difficult to directly acquire the rate of inputting to the buffer 32, it is also difficult to acquire increasing and decreasing trends in the rate of inputting to the buffer 32 directly from the rate of inputting to the buffer 32. According to the embodiment, increasing and decreasing trends in the rate of inputting to the buffer 32 may be monitored by the simple configuration.

According to the embodiment, each of the policers 20 includes a token monitoring section 23 that monitors the amount of tokens accumulated in a token bucket and determines whether or not a target flow of the policer 20 is a flow of burst traffic. Thus, a flow of burst traffic may be identified by the simple configuration.

According to the embodiment, for example, if the result of monitoring the input rate is higher than the rate of 80% of the reading bandwidth of the buffer 32 and equal to or lower than the rate of 100% of the reading bandwidth of the buffer 32, burst sizes of all flows are reduced by half. According to the embodiment, for example, if the result of monitoring the input rate is higher than the rate of 100% of the reading bandwidth of the buffer 32, the burst sizes of all the flows are reduced to 0. Thus, according to the embodiment, burst sizes are reduced by the reduction values based on the ratios of input rates to the reading bandwidth of the buffer 32. Thus, an effect of the reductions in the burst sizes on flows is the discarding of frames in the policers 20 or the like and may be adjusted based on the rate of inputting to the buffer 32.

Storage Medium

A program that causes a computer or another machine or device (hereinafter referred to as computer or the like) to achieve any of the aforementioned functions may be stored in a storage medium readable by the computer or the like. The function may be provided by causing the computer or the like to read and execute the program stored in the storage medium.

The storage medium readable by the computer or the like is a non-transitory storage medium that electrically, magnetically, optically, mechanically, or chemically accumulates information such as data and the program, and the information stored in the storage medium may be read by the computer or the like. The storage medium may be detachable from the computer or the like. If the storage medium is detachable from the computer or the like, the storage medium may be a flexible disk, a magneto-optical disc, a CD-ROM, a CD-R/W, a DVD, a Blu-ray disc, a DAT, an 8 mm tape, a memory card such as a flash memory, or the like. The storage medium may be fixed to the computer or the like. If the storage medium is fixed to the computer or the like, the storage medium may be a hard disk, a read only memory (ROM), or the like. In addition, a solid state drive (SSD) may be used as the storage medium if the storage medium is detachable from the computer or the like or is fixed to the computer or the like.

Processor

The program that achieves any of the functions may be executed by a central processing unit (CPU). The CPU is also referred to as microprocessor (MPU) or processor. The CPU is not limited to a single processor and may have a multiprocessor configuration. The single CPU may be connected to a single socket and have a multicore configuration. One or more of the processes of the aforementioned sections may be executed by a processor other than the CPU or by a dedicated processor such as a DSP or a network processing unit (NPU).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing device comprising:
a buffer that stores data blocks of a plurality of flows and from which the data blocks are sequentially read;
a processor coupled to the buffer and configured to:
monitor an input rate that is a sum of data amounts of the plurality of flows input to the buffer per unit of time, and
suppress flowing of a data block into the buffer for one or more of the plurality of flows based on a result of monitoring the input rate.

2. The information processing device according to claim 1,
wherein the processor is configured to suppress flowing of the data block into the buffer for one or more of the plurality of flows based on the input rate, an increasing or decreasing trend in the input rate, and a reading bandwidth that is amount of data readable from the buffer per unit of time.

3. The information processing device according to claim 2, wherein the processor is configured to
suppress flowing of a data block into the buffer for one or more of the plurality of flows when the input rate is higher than a first threshold equal to or lower than the reading bandwidth and tends to increase.

4. The information processing device according to claim 3, wherein the processor is configured to
suppress flowing of the data blocks into the buffer for all of the plurality of flows when the input rate is equal to or higher than a second threshold higher than the first threshold and equal to or lower than the reading bandwidth and tends to increase.

5. The information processing device according to claim 2, wherein the processor is configured to:
stop flowing of the data block into the buffer for a flow that is among the plurality of flows and satisfies a first requirement for determining that the flow includes burst traffic when the input rate is higher than the reading bandwidth and tends to be maintained; and
suppress flowing of the data block into the buffer for the flow that is among the plurality of flows and does not satisfy the first requirement.

6. The information processing device according to claim 2, wherein the processor is configured to:
monitor the amount of data existing in the buffer; and
promote the data block to flow into the buffer for the one or more flows for which the flow of the data block into the buffer is suppressed, based on the reading bandwidth, the input rate, the amount of the data existing in the buffer, and an increasing or decreasing trend in the input rate.

7. The information processing device according to claim 5,
wherein the first requirement is based on one or more of the amount of an excess token when the amount of tokens accumulated in a token bucket exceeds an upper limit of the amount of tokens capable of being accumulated in the token bucket within a first time period, the amount of data discarded due to the input rate exceeding a set bandwidth within a second time period, the number of times that a burst has occurred within a third time period, and the ratio of the amount of tokens accumulated in the token bucket to the upper limit of the token bucket.

8. The information processing device according to claim 2, wherein the processor is configured to:
monitor, in a cycle based on an input rate threshold determined based on the reading bandwidth, whether or not the input rate reaches the input rate threshold using one or more token buckets to which tokens in an amount corresponding to the input rate threshold are added; and
estimate an increasing or decreasing trend in the input rate based on the difference between the amount of data input to the buffer in the cycle based on the reading bandwidth and the amount data read from the buffer in the cycle based on the reading bandwidth.

9. An information processing method executed by a processor of an information processing device including a buffer that stores data blocks of a plurality of flows and from which the data blocks are sequentially read, the information processing method comprising:
monitoring an input rate that is a sum of data amounts of the plurality of flows input to the buffer per unit of time; and
suppress flowing of a data block into the buffer for one or more of the plurality of flows based on a result of monitoring the input rate.

10. An information processing device comprising:
a plurality of policers that control the output of input data blocks using token buckets, each of which has a maximum value of tokens capable of being accumulated;
a buffer that collects the data blocks output from the plurality of policers and outputs the data blocks; and
a plurality of processors included in the plurality of policers and configured to control the maximum values of tokens capable of being accumulated in the token buckets based on a burst occurrence state and an input rate that is the amount of data to be input to the buffer per unit of time.

11. The information processing device according to claim 10,
wherein each of the processors controls the maximum value of tokens capable of being accumulated in a respective one of the token buckets, based on the input rate, an increasing or decreasing trend in the input rate, a reading bandwidth indicating the amount of data capable of being read from the buffer per unit of time, and the burst occurrence state.

12. The information processing device according to claim 11,
wherein each of the processors reduces the maximum value of tokens capable of being accumulated in a respective one of the token buckets to a predetermined value when the input rate is higher than a first threshold equal to or lower than the reading bandwidth.

13. The information processing device according to claim 12,
wherein each of the processors reduces the maximum value of tokens capable of being accumulated in a respective one of the token buckets to a predetermined value when the input rate is equal to or higher than a second threshold larger than the first threshold and equal to or lower than the reading bandwidth and tends to increase.

14. The information processing device according to claim 11,
wherein each of the processors reduces the maximum value of tokens capable of being accumulated in a respective one of the token buckets to a predetermined value when the input rate is higher than the reading bandwidth and tends to be maintained.

15. The information processing device according to claim 11,
wherein each of the processors increases the maximum value of tokens capable of being accumulated in a respective one of the token buckets to a predetermined value based on the reading bandwidth, the input rate, the amount of data existing in the buffer, and an increasing or decreasing trend in the input rate.

16. The information processing device according to claim 10, wherein each of the processors is configured to:
monitor the amount of tokens accumulated in a respective one of the token buckets; and
determine that a burst has occurred, based on the amount of tokens accumulated in a respective one of the token buckets.

17. The information processing device according to claim 16, wherein each of the processors is configured to:
determine that a burst has occurred, based on one or more of the amount of an excess token when the amount of tokens added to a respective one of the token buckets in a predetermined cycle exceeds the maximum value of tokens capable of being accumulated in the token bucket within a predetermined time period, the amount of data discarded within the predetermined time period or the number of times that data has been discarded since a token is not accumulated in the token bucket, and the ratio of the amount of tokens accumulated in the token bucket to the maximum value of tokens capable of being accumulated in the token bucket.
